(19) United States
(12) Patent Application Publication
(10) Pub. No.: US 2026/0292172 A1
(43) Pub. Date: Sep. 24, 2026

(54) CROSS COMPONENT PREDICTION

(71) Applicant: Tencent Technology (Shenzhen) Company Limited, Shenzhen (CN)

(72) Inventors: Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/688,384

(22) Filed: May 26, 2026

Related U.S. Application Data
(63) Continuation of application No. PCT/CN2025/077524, filed on Feb. 17, 2025.

(30) Foreign Application Priority Data
Mar. 14, 2024 (CN) 202410297228.5

(51) Int. Cl. H04N 19/119; H04N 19/159; H04N 19/167; H04N 19/176; H04N 19/186

(52) U.S. Cl. CPC H04N 19/119; H04N 19/159; H04N 19/167; H04N 19/176; H04N 19/186

(57) ABSTRACT

A target region of a second coding block is determined based on a position of the second coding block in a coding unit. The target region is associated with at least one first coding block. The coding unit includes the at least one first coding block in a first color component and the second coding block in a second color component. Reconstructed samples in the target region are determined according to a prediction mode. When a number of non-zero coefficients in the target region of the first color component or in the at least one first coding block is greater than a threshold, a value of a sample in the second coding block is predicted based on at least one of the reconstructed samples in the target region and a mapping relationship between the at least one of the reconstructed samples and the value of the sample.

### RELATED APPLICATIONS

This application is a continuation of International Application No. PCT/CN2025/077524, filed on Feb. 17, 2025, which claims priority to Chinese Patent Application No. 202410297228.5, filed on Mar. 14, 2024. The entire disclosures of the prior applications are hereby incorporated by reference.

### FIELD OF THE TECHNOLOGY

This disclosure belongs to the field of audio/video technologies, including an image processing method, an image processing apparatus, a computer-readable storage medium, an electronic device, and a computer program product.

### BACKGROUND OF THE DISCLOSURE

To accommodate large-scale data transmission of audio/video data, raw audio/video data needs to be encoded at a data sending end to form a compressed data stream. After the data stream is transmitted to a data receiving end, the data stream is decoded, to restore prediction-based reconstructed audio/video data.

However, an audio/video encoding/decoding solution in related technologies has problems such as low efficiency and accuracy of encoding and decoding.

### SUMMARY

This disclosure includes an image processing method, an image processing apparatus, a computer-readable storage medium, an electronic device, and a computer program product, to improve efficiency and accuracy of video encoding and decoding.

According to an aspect, an image processing method is disclosed. A target region of a second coding block is determined based on a position of the second coding block in a coding unit in a current picture. The target region is associated with at least one first coding block. The coding unit includes the at least one first coding block in a first color component and the second coding block in a second color component. Reconstructed samples in the target region are determined according to a prediction mode. A value of a sample in the second coding block is predicted based on at least one of the reconstructed samples in the target region and a mapping relationship between the at least one of the reconstructed samples in the target region of the first color component and the value of the sample in the second coding block of the second color component. The prediction is performed when one of (i) a number of non-zero coefficients in the target region of the first color component or (ii) a number of non-zero coefficients in the at least one first coding block of the first color component is greater than a threshold.

According to an aspect, an embodiment of this disclosure provides an image processing method, performed by an electronic device. The method includes:
segmenting a current video frame, to obtain at least one first image block and a second image block, the first image block being a coding unit having a first color component, and the second image block being a coding unit having a second color component;
determining, based on a position of the second image block in the current video frame, a coding region associated with the position in the at least one first image block as a target region;
obtaining a reconstructed value of a first color component of the target region through prediction according to a preset prediction mode; and
mapping the reconstructed value of the first color component of the target region based on a mapping relationship between the first color component and the second color component in response to that a preset prediction condition is satisfied, to obtain a predicted value of the second color component of the second image block.

An aspect of the disclosure includes an image processing apparatus. The image processing apparatus includes processing circuitry configured to determine, based on a position of a second coding block in a coding unit in a current picture, a target region of the second coding block. The target region is associated with at least one first coding block. The coding unit includes the at least one first coding block in a first color component and the second coding block in a second color component. The processing circuitry is further configured to determine reconstructed samples in the target region according to a prediction mode. A value of a sample in the second coding block is predicted by the processing circuitry based on at least one of the reconstructed samples in the target region and a mapping relationship between the at least one of the reconstructed samples in the target region of the first color component and the value of the sample in the second coding block of the second color component. The prediction is performed when one of (i) a number of non-zero coefficients in the target region of the first color component or (ii) a number of non-zero coefficients in the at least one first coding block of the first color component is greater than a threshold.

According to another aspect, an embodiment of this disclosure provides an image processing apparatus. The apparatus includes:
a segmentation module, configured to segment a current video frame, to obtain at least one first image block and a second image block, the first image block being a coding unit having a first color component, and the second image block being a coding unit having a second color component;
a determining module, configured to determine, based on a position of the second image block in the current video frame, a coding region associated with the position in the at least one first image block as a target region;
a prediction module, configured to obtain a reconstructed value of a first color component of the target region through prediction according to a preset prediction mode; and
a mapping module, configured to map the reconstructed value of the first color component of the target region based on a mapping relationship between the first color component and the second color component in response to that a preset prediction condition is satisfied, to obtain a predicted value of the second color component of the second image block.

According to another aspect, an embodiment of this disclosure provides a computer-readable storage medium, having a computer program stored therein, the computer program, when executed by a processor, implementing the image processing method according to the foregoing technical solutions.

A non-transitory computer-readable storage medium is disclosed according to another aspect, The storage medium stores instructions which, when executed by a processor, cause the processor to perform a method of encoding a bitstream. In the method of encoding the bitstream, a target region of a second coding block is determined based on a position of the second coding block in a coding unit in a current picture. The target region is associated with at least one first coding block. The coding unit includes the at least one first coding block in a first color component and the second coding block in a second color component. Reconstructed samples in the target region are determined according to a prediction mode. A value of a sample in the second coding block is predicted based on at least one of the reconstructed samples in the target region and a mapping relationship between the at least one of the reconstructed samples in the target region of the first color component and the value of the sample in the second coding block of the second color component. The prediction is performed when one of (i) a number of non-zero coefficients in the target region of the first color component or (ii) a number of non-zero coefficients in the at least one first coding block of the first color component is greater than a threshold.

According to another aspect, an embodiment of this disclosure provides an electronic device. The electronic device includes: a processor; and a memory, configured to store executable instructions of the processor. The processor is configured to execute the executable instructions to implement the image processing method according to the foregoing technical solutions.

According to another aspect, an embodiment of this disclosure provides a computer program product, including a computer program. The computer program is stored in a computer-readable storage medium; and when a processor of an electronic device reads the computer program from the computer-readable storage medium, the processor executes the computer program, to cause the electronic device to perform the image processing method according to the foregoing technical solutions.

### BRIEF DESCRIPTION OF THE DRAWINGS

Accompanying drawings herein are incorporated into this specification and constitute a part of this specification, illustrate embodiments that conform to this disclosure, and are adopted for describing the principle of this disclosure together with this specification. The accompanying drawings described below are merely some embodiments of this disclosure, and a person of ordinary skill in the art may further derive other accompanying drawings from these accompanying drawings.

FIG. 1 is a schematic diagram of an example system architecture to which the technical solutions in the embodiments of this disclosure may be applied.

FIG. 2 schematically shows placement of a video encoding apparatus and a video decoding apparatus in a streaming transmission environment.

FIG. 3 is a schematic basic flowchart of a video coder.

FIG. 4 is a flowchart of an image processing method according to an embodiment of this disclosure.

FIG. 5A is an example of a cross-component linear model (CCLM) prediction process according to an embodiment of this disclosure.

FIG. 5B is a schematic diagram of a process of performing color component sampling on a current block according to an embodiment of this disclosure.

FIG. 6 schematically shows division results of a plurality of block division modes.

FIG. 7 shows an image block obtained by performing image segmentation on a luminance component and a chrominance component by using different partitioning tree structures in an application scenario.

FIG. 8 is a flowchart of fitting a prediction model configured for representing a mapping relationship between color components according to an embodiment of this disclosure.

FIG. 9 is a schematic diagram of a relationship between a specified pixel point and a neighborhood pixel point according to an embodiment of this disclosure.

FIG. 10 is a schematic diagram of distribution of a reference region corresponding to a current block according to an embodiment of this disclosure.

FIG. 11 is a schematic diagram of a region template of combining some subregions into a reference region according to an embodiment of this disclosure.

FIG. 12 is a schematic diagram of a region template of a reference region selected for a current block according to an embodiment of this disclosure.

FIG. 13 is a schematic diagram of selecting a sampling position based on position coordinates of a pixel point according to an embodiment of this disclosure.

FIG. 14 is a schematic diagram of selecting a sampling position in a round-trip scanning manner according to an embodiment of this disclosure.

FIG. 15 is a schematic diagram of selecting a sampling position in a zigzag scanning manner according to an embodiment of this disclosure.

FIG. 16 is a schematic diagram of a sampling window of downsampling a first color component according to an embodiment of this disclosure.

FIG. 17 is a structural block diagram of an image processing apparatus according to an embodiment of this disclosure.

FIG. 18 is a structural block diagram of an electronic device suitable for implementing the embodiments of this disclosure.

### DETAILED DESCRIPTION

Implementations are described in a more comprehensive mode with reference to the accompanying drawings. However, the implementations may be implemented in a plurality of forms, and are not construed as being limited to examples described herein. On the contrary, these implementations are provided to make this disclosure more comprehensive and convey the concept of the implementations to a person skilled in the art.

In addition, the features, structures, or characteristics described in this disclosure may be combined in one or more embodiments in any suitable manner. The following descriptions provide details in various examples, to comprehensively understand embodiments of this disclosure. However, a person of ordinary skill in the art is to be aware that the technical solutions in this disclosure may be implemented without one or more of the particular details, or another method, unit, apparatus, or operation may be used. In other cases, well-known methods, apparatuses, implementations, or operations are not shown or described in detail to avoid obscuring aspects of this disclosure.

In the embodiments of this disclosure, the term “module” or “unit” refers to a computer program with a predetermined function or a part of the computer program and works, together with other related parts, to achieve a predetermined objective, and may be completely or partially achieved by software, hardware (for example, a processing circuit or a memory) or a combination thereof. Similarly, one processor (or a plurality of processors or memories) may be used to implement at least one module or unit. In addition, each module or unit may be a part of an entire module or unit including functions of the module or the unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The block diagrams shown in the drawings are merely functional entities, and do not necessarily correspond to physically independent entities. In other words, the functional entities may be implemented in a form of software, or may be implemented in at least one hardware module or integrated circuit, or may be implemented in different networks and/or processor apparatuses and/or microcontroller apparatuses.

The flowcharts shown in the accompanying drawings are merely non-limiting descriptions, do not need to include all content and operations/steps, and do not need to be performed in the described orders either. For example, some operations/steps may be further divided, while some operations/steps may be combined or partially combined. Therefore, an actual execution order may change according to an actual case.

Relevant technical terms involved in the embodiments of this disclosure are explained below.

Video coding means processing a picture sequence to form a video or a video sequence. In the field of video coding, terms “picture”, “frame”, or “image” may be used as synonyms.

Video coding used in the embodiments of this disclosure represents video encoding or video decoding. The video encoding is performed on a source side, and includes processing (for example, compressing) an original video image to reduce an amount of data required for representing the video image, so that more efficient storage and/or transmission are performed. The video decoding is performed on a destination side. Inverse processing is performed relative to an encoder, to reconstruct a video image. In the embodiments of this disclosure, “coding” a video frame may also be understood as “encoding” or “decoding” a video image sequence. A combination of an encoding part and a decoding part is also referred to as encoding/decoding.

In the embodiments of this disclosure, each image in a video image sequence is segmented into a set of non-overlapping blocks, and coding is performed at a block level. An encoder side encodes a video, which means that at the block (also referred to as an image block or a video block) level, the encoder side generates a prediction block through spatial (intra-image) prediction and temporal (inter-image) prediction, subtracts the prediction block from a current block (a block currently being processed or a block to be processed) to obtain a residual block, and transforms and quantizes the residual block in a transform domain to reduce an amount of data to be transmitted (or to be compressed). A decoder side applies an inverse processing part relative to the encoder to an encoded block or a compressed block, to reconstruct a current block.

In addition, the encoder copies cyclic processing of the decoder side, so that the encoder and the decoder generate the same prediction (for example, intra-frame prediction and inter-frame prediction) block and/or the same reconstruction block for coding of a subsequent block.

The term “block” is a part of an image or a frame. In the embodiments of this disclosure, the current block is a block that is being processed currently. For example, during encoding, the current block is a block that is being encoded currently; and during decoding, the current block is a block that is being decoded currently.

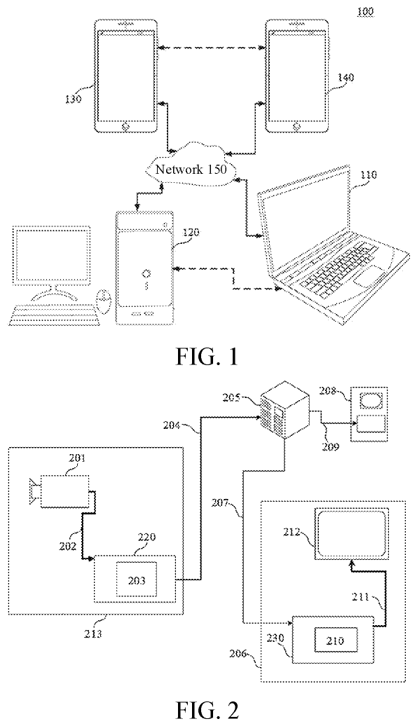

FIG. 1 is a schematic diagram of an example system architecture to which the technical solutions in the embodiments of this disclosure may be applied.

As shown in FIG. 1, a system architecture 100 includes a plurality of terminal apparatuses. The terminal apparatuses may communicate with each other, for example, via a network 150. For example, the system architecture 100 may include a first terminal apparatus 110 and a second terminal apparatus 120 that are interconnected via a network 150. In the embodiment of FIG. 1, the first terminal apparatus 110 and the second terminal apparatus 120 perform unidirectional data transmission.

For example, the first terminal apparatus 110 may encode video data (for example, a video picture stream collected by the terminal apparatus 110), to transmit the video data to the second terminal apparatus 120 via the network 150. Encoded video data is transmitted in a form of at least one encoded video stream. The second terminal apparatus 120 may receive the encoded video data from the network 150, decode the encoded video data to restore the video data, and display a video picture based on the restored video data.

In an embodiment of this disclosure, the system architecture 100 may include a third terminal apparatus 130 and a fourth terminal apparatus 140. The third terminal apparatus 130 and the fourth terminal apparatus 140 may perform bidirectional transmission of the encoded video data. For example, the bidirectional transmission may occur during a video conference. For bidirectional data transmission, each of the third terminal apparatus 130 and the fourth terminal apparatus 140 may encode video data (for example, a video picture stream collected by a terminal apparatus), to transmit the encoded video data to the other one of the third terminal apparatus 130 and the fourth terminal apparatus 140 via the network 150. Each of the third terminal apparatus 130 and the fourth terminal apparatus 140 may further receive encoded video data transmitted by the other one of the third terminal apparatus 130 and the fourth terminal apparatus 140, decode the encoded video data to restore video data, and display a video picture on an accessible display apparatus based on the restored video data.

In the embodiment of FIG. 1, the first terminal apparatus 110, the second terminal apparatus 120, the third terminal apparatus 130, and the fourth terminal apparatus 140 may be servers, personal computers, or smart phones, but this disclosure is not limited thereto. The embodiments disclosed in this disclosure are applicable to a laptop computer, a tablet computer, a media player, and/or a dedicated video conferencing device. The network 150 represents any quantity of networks that include, for example, a wired and/or wireless communication network and transmit coded video data between the first terminal apparatus 110, the second terminal apparatus 120, the third terminal apparatus 130, and the fourth terminal apparatus 140. The communication network 150 may be configured for exchanging data in circuit-switched and/or packet-switched channels. The network may include a telecommunications network, a local area network, a wide area network, and/or the Internet.

In an embodiment of this disclosure, FIG. 2 is a schematic diagram of placement of a video encoding apparatus and a video decoding apparatus in a streaming transmission environment. The subject disclosed in this disclosure may be equally applicable to other video-enabled applications, including, for example, a video conference, a digital television (TV), and storage of compressed video on digital media including a compact disc (CD), a digital video disc (DVD), a memory stick, and the like.

A streaming transmission system may include a collection subsystem 213. The collection subsystem 213 may include a video source 201 such as a digital camera. The video source 201 creates an uncompressed video picture stream 202. In this embodiment, the video picture stream 202 includes a sample photographed by the digital camera. The video picture stream 202 is depicted as a bold line to emphasize the video picture stream with a high data volume when compared with encoded video data 204 (or an encoded video bitstream 204). The video picture stream 202 may be processed by an electronic apparatus 220. The electronic apparatus 220 includes a video encoding apparatus 203 coupled to the video source 201. The video encoding apparatus 203 may include hardware, software, or a combination of software and hardware, to implement or perform each embodiment described in more detail below.

The encoded video data 204 (or the encoded video bitstream 204) is depicted as a thin line to emphasize the encoded video data 204 (or the encoded video bitstream 204) with a low data volume when compared with the video picture stream 202, and may be stored on a streaming transmission server 205 for future use. At least one streaming transmission client subsystem, such as a client subsystem 206 and a client subsystem 208 in FIG. 2, may access the streaming transmission server 205 to retrieve a copy 207 and a copy 209 of the encoded video data 204.

The client subsystem 206 may include, for example, a video decoding apparatus 210 in an electronic apparatus 230. The video decoding apparatus 210 decodes the input copy 207 of the encoded video data, output a video picture stream 211 that may be displayed on a display 212 (for example, a display screen) or another display apparatus. In some streaming transmission systems, the encoded video data 204, video data 207, and video data 209 (such as video bitstreams) may be coded according to some video coding/compression standards.

The electronic apparatus 220 and the electronic apparatus 230 may include other components not shown. For example, the electronic apparatus 220 may include a video decoding apparatus, and the electronic apparatus 230 may further include a video encoding apparatus.

In an embodiment of this disclosure, international video coding standards, High Efficiency Video Coding (HEVC, H.265) and Versatile Video Coding (VVC, H.266), and the Chinese national video coding standard, Audio Video Coding Standard (AVS), are used as examples, after being inputted, a video frame image is partitioned into a plurality of non-overlapping processing units based on a block size, and a similar compression operation is to be performed on each processing unit. The processing unit is referred to as a coding tree unit (CTU) or a largest coding unit (LCU). Further subdivision of the CTU may be performed to obtain at least one basic coding unit CU. The CU is the most basic element in a coding process.

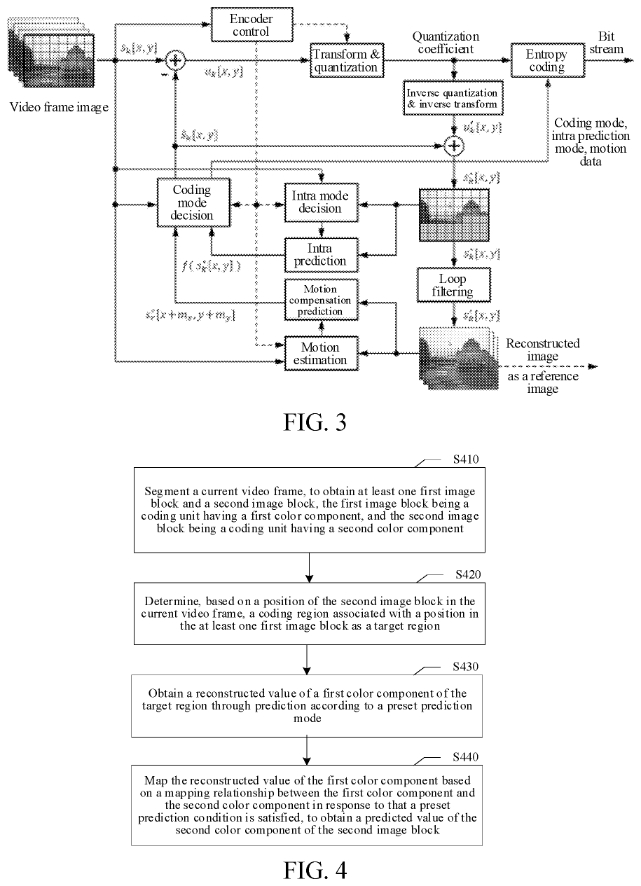

FIG. 3 is a schematic basic flowchart of a video coder. In the process, intra prediction is used as an example for description.

A difference operation is performed on an original image signal sₖ[x, y] and a predicted image signal ŝₖ[x, y], to obtain a residual signal uₖ[x, y]. Transform and quantization are performed on the residual signal uₖ[x, y], to obtain a quantization coefficient. Entropy coding is performed on the quantization coefficient, to obtain an encoded bit stream. In addition, inverse quantization and inverse transform are performed on the quantization coefficient, to obtain a reconstructed residual signal u′ₖ[x, y]. The predicted image signal ŝₖ[x, y] and the reconstructed residual signal u′ₖ[x, y] are superimposed, to generate an image signal

$${s}_{k}^{*} [ x , y ] .$$

The image signal

$${s}_{k}^{*} [ x , y ]$$

is inputted to an intra-frame mode decision module and an intra prediction module, to perform intra prediction. In addition, loop filtering is performed on the image signal

$${s}_{k}^{*} [ x , y ] ,$$

to output a reconstructed image signal s′ₖ[x, y]. The reconstructed image signal s′ₖ[x, y] may be used as a reference image for a next frame for motion estimation and motion compensation prediction. Then, a predicted image signal ŝₖ[x, y] of the next frame is obtained based on a motion compensation prediction result s′ᵣ[x+mₓ, y+m_{y}] and an intra prediction result

$$f ( {s}_{k}^{*} [ x , y ] ) .$$

The foregoing process is repeated until coding is completed.

A coding operation for each CU involved in the foregoing video coding process is described in detail below.

Predictive coding: Predictive coding includes manners such as intra prediction and inter prediction. After an original video signal is subjected to prediction of a selected reconstructed video signal, a residual signal is obtained. An encoding end needs to determine a prediction mode (namely, a coding mode) to be selected for a current CU and notify a decoding end. The intra prediction means that a predicted signal comes from a region that has been encoded and reconstructed in a same image. The inter prediction means that a predicted signal comes from another image (referred to as a reference image) that has been encoded and that is different from a current image.

Transform & quantization: A transform operation, such as discrete Fourier transform (DFT) or discrete cosine transform (DCT), is performed on a residual signal to transform the signal into a transform domain, which is referred to as a transform coefficient. A lossy quantization operation is performed on the transform coefficient, and an amount of information is lost, so that a quantized signal is conductive to compressed expression. In some examples, such as in certain video coding standards, more than one transform mode may be selected. Therefore, the encoding end also needs to select one of the transform modes for the current CU and notify the decoding end. Precision of quantization is determined by a quantization parameter (QP). A larger value of the QP indicates that coefficients within a larger value range are to be quantized into a same output, and therefore results in greater distortion and a lower bit rate. On the contrary, a smaller value of the QP indicates that coefficients within a smaller value range are to be quantized into a same output, and therefore results in smaller distortion and a higher bit rate.

Entropy coding or statistical coding: Statistical compression coding is performed on a quantized signal in a transform domain based on a frequency of occurrence of each value, and finally a binarized (0 or 1) compressed bitstream is outputted. In addition, entropy coding further needs to be performed on other information generated during coding, such as a selected prediction mode and motion vector data, to reduce a bit rate. The statistical coding is a lossless coding mode that can effectively reduce a bit rate required to express a same signal. A common statistical coding mode includes variable length coding (VLC) or context adaptive binary arithmetic coding (CABAC).

A process of CABAC includes three operations: binarization, context modeling, and binary arithmetic coding. After an inputted syntactic element is binarized, binary data may be coded in a normal coding mode and a bypass coding mode.

In the bypass coding mode, a specific probability model does not need to be assigned to each binary bit, and an inputted binary bit (bin) value is directly coded by using a simple bypass coder to speed up an entire encoding and decoding process. In general, different syntactic elements are not entirely independent of each other, and a same syntactic element has a memory property. Therefore, according to a conditional entropy theory, conditional coding performed by using other encoded syntactic elements can further improve coding performance compared with independent coding or memoryless coding. Such encoded symbolic information serving as a condition is referred to as a context.

In a coding mode in related technologies, binary bits of syntactic elements sequentially enter a context modeler. An encoder assigns an appropriate probability model for each inputted binary bit based on a value of a previously encoded syntactic element or binary bit. This process is referred to as context modeling. A context model corresponding to a syntactic element can be located based on a context index increment (ctxIdxInc) and a context index start (ctxIdxStart). After the bin value and the assigned probability model are inputted together to a binary arithmetic encoder for coding, the context model needs to be updated based on the bin value. This is an adaptive process during coding.

Loop filtering: Operations, such as inverse quantization, inverse transform, and predictive compensation, are performed on a transformed and quantized signal to obtain a reconstructed image. The reconstructed image has some information different from that in an original image as a result of quantization, that is, the reconstructed image may cause distortion. Therefore, the reconstructed image may be filtered by using a filter such as a deblocking filter (DB), a sample adaptive offset (SAO) filter, or an adaptive loop filter (ALF), to effectively reduce a degree of distortion caused by quantization. Since reconstructed images subjected to filtering are to be used as a reference for subsequent coding images to predict future image signals, filtering is also referred to as loop filtering, namely, filtering in a coding loop.

Based on the foregoing coding process, for each CU, after obtaining a compressed bitstream (namely, bit stream), the decoding end performs entropy decoding to obtain various mode information and a quantization coefficient. Inverse quantization and inverse transform are then performed on the quantization coefficient, to obtain a residual signal. Moreover, a predicted signal corresponding to the CU may be obtained based on known prediction mode information. Then the residual signal and the predicted signal may be added to obtain a reconstructed signal. The reconstructed signal is then subjected to operations such as loop filtering to generate a final output signal.

The following describes technical solutions such as an image processing method, an image processing apparatus, a computer-readable storage medium, an electronic device, and a computer program product provided in the embodiments of this disclosure in detail with reference to various implementations.

FIG. 4 is a flowchart of an image processing method according to an embodiment of this disclosure. The image processing method may be performed by an electronic device, for example, a terminal device or a server that sends or receives video coding data. In this embodiment of this disclosure, a method performed by a terminal device is used as an example for description. The terminal device may be, for example, the video decoding apparatus 210 or the video encoding apparatus 220 shown in FIG. 2.

As shown in FIG. 4, the image processing method in this embodiment of this disclosure includes the following operations S410 to S440.

S410: Segment a current video frame (also referred to as a current picture or a current picture in a current video), to obtain at least one first image block (also referred to as at least one first coding block) and a second image block (also referred to as a second coding block). In an example, the first image block is a first color component in a coding unit, and the second image block is a second color component of a coding unit. For example, a coding unit includes the at least one first coding block in the first color component (e.g., a luma block of a luma component) and the second coding block in the second color component (e.g., a chroma block of a chroma component). In an example, a partial region or the entire region of the at least one first coding block is collocated with the second coding block.

S420: Determine, based on a position of the second image block in the current video frame, a coding region associated with the position in the at least one first image block as a target region. In an example, the target region of the second coding block is determined based on the position of the second coding block in the coding unit in the current picture. The target region is associated with the at least one first coding block.

S430: Obtain a reconstructed value (e.g., a value of a reconstructed sample) of a first color component of the target region through prediction according to a prediction mode (e.g., a preset prediction mode). In an example, reconstructed samples in the target region are determined according to the prediction mode. The reconstructed samples include the reconstructed sample of the first color component of the target region.

S440: Map the reconstructed value of the first color component based on a mapping relationship between the first color component (e.g., the at least one of the reconstructed samples in the target region of the first color component) and the second color component (e.g., the value of the sample in the second coding block of the second color component) in response to that a preset prediction condition is satisfied, to obtain a predicted value (e.g., a predicted value of a sample in the second coding block) of the second color component of the second image block. In an example, the value of the sample in the second coding block is predicted based on at least one of the reconstructed samples in the target region and the mapping relationship between the at least one of the reconstructed samples in the target region of the first color component and the value of the sample in the second coding block of the second color component in response to the preset prediction condition is satisfied. In an example, the preset prediction condition is satisfied when one of (i) a number of non-zero coefficients in the target region of the first color component or (ii) a number of non-zero coefficients in the at least one first coding block of the first color component is greater than a threshold.

In this embodiment of this disclosure, the preset prediction mode in S430 includes an intra prediction mode, an inter prediction mode, or an intra block copy prediction mode. Prediction pixels used when the prediction modes are used are obtained by searching a reconstructed reference frame or a reconstructed region of a current frame, or searching a subpixel interpolation image of the reconstructed reference frame or the reconstructed region of the current frame.

In the related art, a chrominance component has a similar motion vector or block vector to a luminance component. Therefore, a motion vector or block vector of chrominance is simply derived from a motion vector or block vector of luminance. Because in such a matching and searching process, both a matching degree of an image and coding costs of a motion vector or a block vector need to be considered, there is still some space to improve prediction precision.

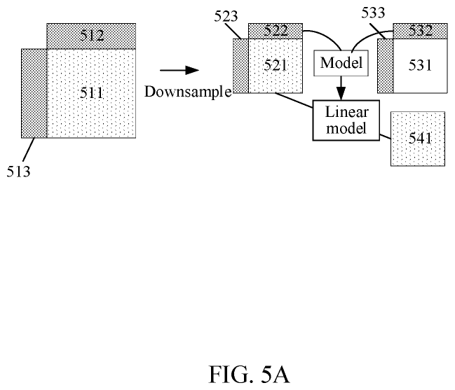

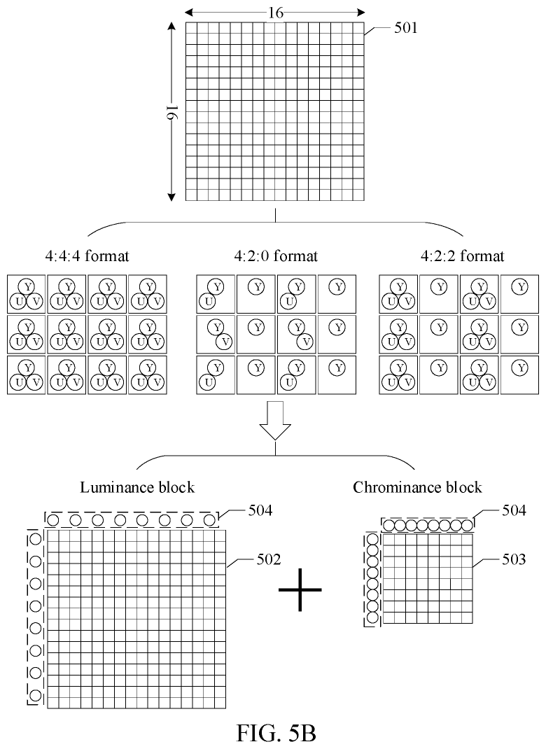

FIG. 5A is an example of a cross-component linear model (CCLM) prediction process in the related art, such as used in the Versatile Video Coding (VVC) standard. Referring to FIG. 5A, a luminance component or a luma component is used to perform cross-component prediction on a chrominance component (or a chroma component). As shown in FIG. 5A, a coding block 511 and a coding block 531 are collocated in a coding unit. For example, the coding block 511 is of the luma component of the coding unit, and the coding block 531 is of the chroma component of the coding unit. A luma template includes reconstructed samples that neighboring the coding block 511. In the example shown in FIG. 5A, the luma template includes regions 512-513. A chroma template includes reconstructed samples that neighboring the coding block 531. In the example shown in FIG. 5A, the chroma template includes regions 532-533. Downsampling is performed on the luminance component including, for example, the coding block 511 and the luma template to obtain a downsampled block 521 and a downsampled luma template of the luminance component. The downsampled luma template includes regions 522-523. A linear model is constructed based on the luma template and the chroma template. For example, the linear model is constructed based on the downsampled luma template (e.g., including the regions 522-523) and the chroma template (e.g., including the regions 532-533). The downsampled luminance component such as the downsampled block 521 is input to the linear model to obtain a predicted chrominance result such as a block 541 of the downsampled block 521. The predicted block 541 is a prediction of the coding block 531.

In the related technology, the prediction model constructed in the CCLM uses a first-order linear model, e.g., y=ax+b, and a template (e.g., a template region) selected for model fitting is relatively small, for example, the template including only one line neighboring each of the coding block (521) and (531), resulting in limited prediction precision.

In this embodiment of this disclosure, the second color component is predicted in a color component mapping prediction manner, cross-component prediction for chrominance is achieved, and a problem of poor prediction precision caused by independent prediction of different color components in a coding solution of related technologies is overcome, so that the cross-component prediction can be used in a luminance-chrominance separate tree, a use range of the cross-component prediction is expanded, and performance of the cross-component prediction method is improved, thereby improving efficiency and accuracy of video encoding and decoding.

S410: For a color video frame, in a color space, an image block may correspond to one color category.

According to an embodiment of this disclosure, color component sampling may be performed on a current block in the color space, to form a luminance block and a chrominance block.

In addition to a luminance component (Y), an image in a color video further includes chrominance components (U, V), and such an image may also be referred to as a YUV image. When a YUV image is encoded, in addition to encoding a luminance component, a chrominance component further needs to be encoded. Because human eyes are relatively sensitive to luminance but not so sensitive to colors, during encoding, to save storage space and improve encoding efficiency, full-resolution sampling may be performed on the luminance component, and full-resolution sampling may not be performed on the chrominance component. According to different methods for sampling a luminance component and a chrominance component in a color video, images of a video sequence usually include a YUV image in a 4:4:4 format, a YUV image in a 4:2:2 format, a YUV image in a 4:2:0 format, and the like.

FIG. 5B is a schematic diagram of a process of performing color component sampling on a current block according to an embodiment of this disclosure. As shown in FIG. 5B, a current block 501 is an image block with a size of 16×16, and when color component sampling is performed on the current block 501, different resolution formats may be selected for sampling.

The 4:4:4 format represents that downsampling is not performed on a chrominance component, and the 4:4:4 format is a format having a highest resolution of the chrominance component. When the 4:4:4 format is used for sampling, one Y component corresponds to a group of UV components, and data in four adjacent pixel points includes four Y components, four U components, and four V components.

The 4:2:2 format represents that 2:1 horizontal downsampling is performed on a chrominance component relative to a luminance component, and there is no vertical downsampling. For every two U sampling points or V sampling points, each row includes four Y sampling points. When the 4:2:2 format is used for sampling, every two Y components share one group of UV components, and data in four adjacent pixel points includes four Y components, two U components, and two V components.

The 4:2:0 format represents that 2:1 horizontal downsampling and 2:1 vertical downsampling are performed on a chrominance component relative to a luminance component. The 4:2:0 format is a format having a lowest resolution of the chrominance component. In the 4:2:0 format, chroma sampling is only half of luminance sampling in each row (that is, a horizontal direction) and only half of the luminance sampling in each column (that is, a vertical direction). When the 4:2:0 format is used for sampling, a U component and a Y component appear alternately. For example, if three components Y, U, V appear in a first row at a ratio of 4:2:0, the three components appear in a second row at a ratio of 4:0:2. There are four Y components, one U component, and one V component in four adjacent pixel points.

When a video image is in the 4:2:0 format, if a luminance component of an image block is an image block of a size 2M×2N, a chrominance component of the image block is an image block of a size M×N. For example, if a resolution of the image block is 720*480, a resolution of the luminance component of the image block is 720*480, and a resolution of the chrominance component of the image block is 360*240.

In this embodiment of this disclosure, the 4:2:0 format is used as an example. A luminance block 502 and a chrominance block 503 may be obtained by sampling the current block 501. The luminance block 502 is a 16×16 image block, and a chrominance block 503 corresponding to the luminance block 502 is an 8×8 image block. 504 shows an image region neighboring to the luminance block 502 and the chrominance block 503.

In S410, the plurality of image regions may be obtained by segmenting the current video frame, and each image region or a combination of a plurality of image regions may be considered as an image block.

In an embodiment of this disclosure, image segmentation (e.g., partition) may be performed on the image block of the first color component and the image block of the second color component based on a same partitioning tree structure (that is, a single partitioning tree structure), to form an image block in a merging mode; or image segmentation may be performed based on different partitioning tree structures (e.g., a luminance-chrominance separate tree), to form an image block in a separation mode. The first color component may be any one of a luminance component Y, a chrominance component U, and a chrominance component V, and the second color component may be another one of the luminance component Y, the chrominance component U, and the chrominance component V.

For example, a partitioning tree structure in AVS3 includes a quaternary tree, a binary tree, and an extended quaternary tree. When a block is relatively large, a luminance block and a chrominance block follow the same block division structure, and the luminance block and the chrominance block are in a one-to-one correspondence, that is, one chrominance block only corresponds to one luminance block. However, when the block is divided into small blocks, the luminance block and chrominance block are separately divided, and the luminance block and the chrominance block are no longer in a one-to-one correspondence, that is, luminance regions corresponding to one chrominance block may be in different luminance blocks.

A frame of image in a video signal may be segmented into coding tree units CTUs that do not overlap with each other. For example, a block size of a CTU may be set to 64×64, 128×128, or the like. For example, a CTU with a block size of 128×128 may be a matrix pixel lattice including 128 columns, each column includes 128 pixels, and each pixel includes a luminance component and/or a chrominance component. Then, more fine-grained division may be performed on the CTU, to obtain a group of coding units CUs. One group of CUs may include at least one CU.

A coding tree unit CTU may be divided by using one or a combination of a plurality of division modes such as a quaternary tree (QT), a binary tree (BT), and a ternary tree (TT). Based on different division directions, the BT may further include a horizontal binary tree (HTT) and a vertical binary tree (VBT), and the TT may further include a horizontal ternary tree (HTT) and a vertical ternary tree (VTT).

For a CTU, the CTU may be used as a root node, and divided into several nodes. One node corresponds to one image region. If a node no longer continues to be divided, the node is referred to as a leaf node, and an image region corresponding to the node forms a CU. If the node continues to be divided, the node may be divided into a plurality of subregions by using the foregoing one or a combination of the plurality of division modes. Each subregion corresponds to one child node, and then whether these child nodes further continue to be divided needs to be separately determined.

For example, assuming that a division level of the root node is 0, a division level of a child node may be a division level of a parent node plus 1. In a video coding process, an encoder sets a minimum block size of a CU. In a division process, if a block size of a node is equal to the minimum block size, the node does not continue to be divided by default. For ease of description, an “image region corresponding to a node” is briefly referred to as a “node” below. For a node, the QT division mode may be used, to divide the node into four subnodes. According to the QT division mode, the node may be divided into four subnodes having the same block size. The subnodes have the same width and the same height, the width is half of a width of the node before the division, and the height is half of a height of the node before the division.

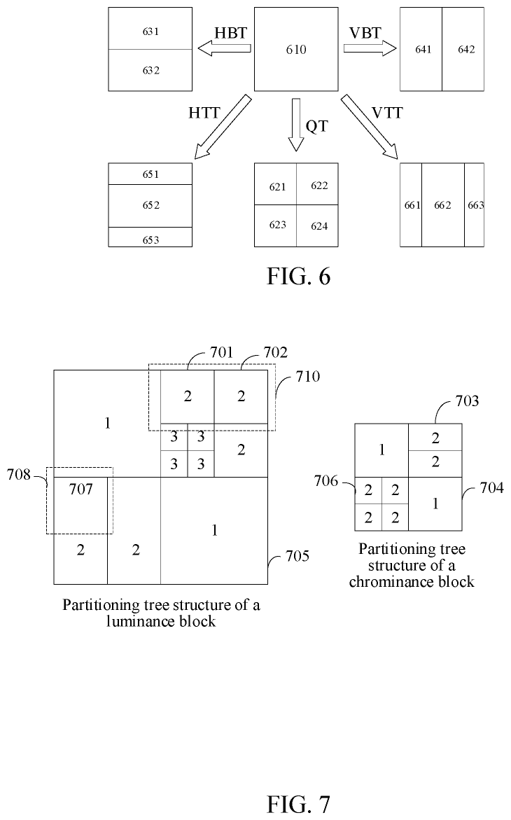

FIG. 6 schematically shows division results of a plurality of block division modes. As shown in FIG. 6, for a node 610 with a block size of 64×64, if the node 610 no longer continues to be divided, the node 610 is directly determined as one CU with a block size of 64×64. If the node 610 continues to be divided, the node 610 may be divided into four nodes 621 to 624 with a block size of 32×32 according to the QT division mode. For a node in the four nodes 621 to 624 with the block size of 32×32, if the node continues to be divided, four nodes with a block size of 16×16 are generated.

For a node, the BT division mode may be used, to divide the node into two subnodes. In some embodiments, the BT division mode includes two types: the HBT division mode and the VBT division mode. According to the HBT division mode, the node is divided into two subnodes having the same block size, that is, an upper subnode and a lower subnode. The subnodes have the same width and the same height, the width is equal to a width of the node before the division, and the height is half of a height of the node before the division. According to the VBT division mode, the node is divided into two subnodes having the same size, that is, a left subnode and a right subnode. The subnodes have the same width and the same height, the width is half of a width of the node before the division, and the height is equal to a height of the node before the division.

For example, as shown in FIG. 6, for the node 610 with the block size of 64×64, if the node 610 may be divided into two nodes 631 and 632 with a block size of 64×32 according to the HBT division mode, or the node 610 may be divided into two nodes 641 and 642 with a block size of 32×64 according to the VBT division mode.

For a node, the TT division mode may be used, to divide the node into three subnodes. In some embodiments, the TT division mode includes two types: the HTT division mode and the VTT division mode. According to the HTT division mode, the node is divided into three subnodes, that is, an upper subnode, a middle subnode, and a lower subnode, as shown by 651 to 653 in FIG. 6. Widths of the upper subnode 651 and the lower subnode 653 is equal to a width of the node 610 before the division, and heights of the upper subnode 651 and the lower subnode 653 are a quarter of a height of the node 610 before the division. A width of the middle node 652 is equal to the width of the node before the division, and a height of the middle node 652 is half of the height of the node before the division. According to the VTT division mode, the node is divided into three subnodes, that is, a left subnode, a middle subnode, and a right subnode, as shown by 661 to 663 in FIG. 6. Widths of the left subnode 661 and the right subnode 663 are a quarter of a width of the node 610 before the division, and heights of the left subnode 661 and the right subnode 663 are equal to a height of the node 610 before the division. A width of the middle node 662 is half of the width of the node before the division, and a height of the middle node 662 is equal to the height of the node before the division.

In an embodiment of this disclosure, when the first image block (e.g., the first coding block) and the second image block (e.g., the second coding block) have the same partitioning tree structure, the current video frame (e.g., the current picture) may be segmented based on a single partitioning tree structure, to obtain the at least one first image block and the second image block. In this case, based on the position of the second image block in the current video frame, an entire region of one first image block corresponding to the second image block in the at least one first image block may be determined as the target region. In other words, a complete first image block corresponding to the second image block exists in the at least one first image block, and an entire region of the first image block is determined as the target region. In an example, the single partitioning tree structure is used to partition the current picture, and thus blocks in the first color component (e.g., luma blocks) and blocks in the second color component (e.g., chroma blocks) have the same block partitioning structure. Accordingly, the blocks in the first color component (e.g., the luma blocks) and the blocks in the second color component (e.g., chroma blocks) correspond to each other, and one chroma block maps to only one luma coding block that is collocated with the one chroma block. In an example, the second coding block (e.g., a chroma block) is collocated with the first coding block (e.g., a luma block). For example, the second coding block corresponds to the first coding block alone, and the first coding block corresponds to the second coding block alone.

In an example, the current picture is partitioned based on the single partitioning tree structure to obtain the at least one first coding block and the second coding block. A coding block in the at least one first coding block corresponds to the second coding block is the target region, and the target region is collocated with the second coding block. The number of non-zero coefficients of the entire coding block in the at least one first coding block is greater than the threshold.

In another embodiment of this disclosure, when the first image block and the second image block have different partitioning tree structures, the current video frame may be segmented based on a first partitioning tree structure, to obtain the at least one first image block; and the current video frame may be segmented based on a second partitioning tree structure, to obtain the second image block. In this case, based on the position of the second image block in the current video frame, a partial or an entire region corresponding to the second image block in the at least one first image block may be determined as the target region. In an example, target region (e.g., the partial or the entire region corresponding to the second image block) is in the at least one first image block. In other words, not only one first image block corresponding to the second image block exists in the at least one first image block. Therefore, a partial or an entire region corresponding to the second image block in the at least one first image block may be determined as the target region. In an example, different partitioning tree structures (also referred to as separate partition tree structures including, for example, a first partitioning tree structure and a second partitioning tree structure) are used to partition the current picture, and thus the blocks in the first color component (e.g., the luma blocks) and the blocks in the second color component (e.g., the chroma blocks) have the different partitioning structures. Accordingly, a block in the first color component (e.g., a luma block) and a block in the second color component (e.g., a chroma block) may or may not correspond to each other. In an example, a luma region corresponding to the single chroma block span across different luma coding blocks.

In an aspect, a first color component of the current picture is partitioned based on the first partitioning tree structure to obtain the at least one first coding block. A second color component of the current picture is partitioned based on the second partitioning tree structure to obtain the second coding block. A partial region or an entire region in the at least one first coding block is the target region, the target region is collocated with the second coding block. The first partitioning tree structure is different from the second partitioning tree structure.

In an example, when the different partitioning tree structures are used to partition the current picture, the number of non-zero coefficients of the target region of the first color component is greater than the threshold.

In an example, when the different partitioning tree structures are used to partition the current picture, the at least one first coding block is a first coding block, and the target region of the first color component is one of: (i) a partial region of the first coding block and (ii) an entire region of the first coding block.

In an example, when the different partitioning tree structures are used to partition the current picture, the at least one first coding block includes a plurality of first coding blocks, and the target region of the first color component is one of: (i) a partial region of the plurality of first coding blocks and (ii) an entire region of the plurality of first coding blocks.

In an example, when the different partitioning tree structures are used to partition the current picture, the number of non-zero coefficients in the at least one first coding block that corresponds to the target region is greater than the threshold. When the at least one first coding block includes a plurality of first coding blocks, the partial region in the plurality of first coding blocks is the target region, and the number of non-zero coefficients in the entire region of the plurality of first coding blocks is greater than the threshold. When the at least one first coding block is a first coding block, the partial region in the first coding block is the target region, the number of non-zero coefficients in the entire region of the first coding block is greater than the threshold.

For example, in VTM7, an image segmentation solution may support a luminance block and a chrominance block in one CTU having an independent partitioning tree structure. For example, for a P frame and a B frame, a luminance block and a chrominance block in one CTU share the same partitioning tree structure, that is, a luminance-chrominance combination mode. However, for an I frame, a luminance block and a chrominance block in one CTU may have different partitioning tree structures, that is, a luminance-chrominance separation mode. When different image segmentation modes are used, a luminance block may be divided into luminance CUs (whose size may be smaller) based on a coding tree structure, and a chrominance block may be divided into chrominance CUs based on another coding tree structure. This means that CUs in an I frame may include a CU of a luminance component or CUs of two chrominance components, unless a video is monochrome; and CUs in a P frame or a B frame may always include CUs of all three color components, that is, a CU of a luminance component and CUs of two chrominance components.

In some embodiments, an image segmentation solution of a semi-decoupled tree (SDT) may be used, and is also referred to as flexible block division of a semi-separate tree (SST) or flexible block division for chrominance components. In the SDT, a luminance block and a chrominance block in a super block (SB) may have the same block division manner or different block division manners, depending on a block size of the luminance block or a depth of a luminance tree. For example, when the block size of the luminance block is greater than a threshold T1 or a coding tree splitting depth of the luminance block is less than or equal to a threshold T2, a coding tree structure the same as that of the luminance block may be used for a chrominance block associated with the luminance block; or when the block size of the luminance block is less than or equal to T1 or the luminance split depth of the luminance block is greater than T2, the associated chrominance block and the luminance block may have different block division manners. Therefore, this solution is referred to as flexible block division for chrominance components. T1 is a positive integer, for example, 128 or 256. T2 is a positive integer, for example, 1 or 2.

FIG. 7 shows an image block obtained by performing image segmentation on a luminance component and a chrominance component by using different partitioning tree structures in an application scenario. Numbers 1, 2, and 3 on the image blocks indicate orders of segmentation. T2 is set to 1. That is, when a luminance splitting depth of a luminance block is greater than 1, a segmentation data structure different from that of the luminance block is used for a chrominance block associated with the luminance block. In this case, based on a position of 703 in a current video frame, it may be determined that 703 corresponds to 701 and 702 in the luminance block, and then a partial or an entire region 710 of 701 and 702 may be determined as the target region.

Referring to FIG. 7, in an example, the second coding block 703 is collocated with or maps to a region 710. The region 710 includes the first coding blocks 701 and 702. In an example, the region 710 is the target region for the second coding block 703.

In an example, a second coding block 704 is collocated with or maps to a first coding block 705. In an example, the first coding block 705 is the target region for the first coding block 704.

In an example, a second coding block 706 is collocated with or maps to a portion 708 of a first coding block 707. In an example shown in FIG. 7, the portion 708 is a top portion of the first coding block 707. In an example, the portion 708 is the target region for the first coding block 706.

In some examples, a second coding block (e.g., a chroma block) maps to a target region that is a portion of a first coding block (e.g., a luma block), the first coding block, or more than the first coding block.

When an improved semi-decoupled partitioning (SDP) solution is used, the luminance block and the chrominance block may share one partial tree structure starting from a root node of a super block. When to start to perform separate tree partitioning schemes on the luminance block and the chrominance block depends on partitioning information of the luminance block or high-level syntax in a bitstream.

In S430, the reconstructed value of the first color component of the target region may be obtained through prediction according to the preset prediction mode. The preset prediction mode may include manners such as inter prediction, intra prediction, or intra block copy prediction. In video coding, main redundant information is temporal redundancy, and secondly, spatial redundancy. In video coding, the temporal redundancy is eliminated through inter prediction, and the spatial redundancy is eliminated through intra prediction. The intra prediction is performing prediction by using a reconstructed value of a neighboring block. In this process, preset weighting processing is performed on a neighboring encoded pixel, to obtain a good estimate of a current pixel block. Two methods may be used for intra prediction: one-dimensional prediction and two-dimensional prediction. The one-dimensional prediction is performing prediction by using correlation between adjacent pixels in a same row. Based on that a value of a current pixel point is relatively close to a previous pixel value of the current pixel point, the previous pixel value may be used as a predicted value of the current pixel point. In the two-dimensional prediction, in addition to an adjacent pixel point in a current row, a pixel point of a previous row is further used for prediction. Corresponding weighted values are assigned to pixel values in different rows, to finally obtain a predicted value.

The inter prediction is performing prediction on a current frame by using correlation between adjacent frames in a video sequence. In a video sequence, there is a relatively high pixel similarity between adjacent frames. Therefore, a pixel value of a current frame may be predicted by using information about a previous frame or a next frame. The inter prediction may be implemented by using processes such as motion estimation, motion compensation, and residual coding. Motion estimation is to find an optimal motion vector to describe a motion relationship between a current frame and a previous frame or a next frame by finding a difference between the current frame and the previous frame or the next frame through comparison. Common motion estimation algorithms may include a full search algorithm, a block matching algorithm, and the like. The motion compensation is correcting a previous frame or a next frame by using a found motion vector, to implement pixel prediction for a current frame. The motion compensation may be implemented in a manner such as pixel copying or interpolation by applying the motion vector to the reference frame. The residual coding is coding a difference between a pixel value of a current frame and a pixel value of a predicted frame, to obtain residual data. The residual data represents pixel information in the current frame that cannot be obtained through motion prediction, and needs to be additionally coded and transmitted.

The intra block copy (IBC) prediction may be considered as a special inter prediction mode. An implementation principle of the intra block copy prediction mode is similar or identical to a principle of a solution of performing motion compensation in an inter prediction mode. A difference lies in that in the inter prediction mode, a reference block configured for performing motion compensation is selected from a reference video frame different from the current video frame, and in the intra block copy prediction mode, a reference block configured for performing motion compensation is selected in the current video frame. In the intra block copy prediction mode, a motion vector represents a relative displacement of moving from a position of a current block to a position of a reference block in a current video frame.

In an embodiment of this disclosure, a prediction model configured to represent a mapping relationship between the first color component and the second color component may be fitted based on the current block and at least one image region in the reference region. The reference region includes at least one nearest or second nearest neighboring decoded image region to the current block.

The second color component is another color component different from the first color component in the color space. For example, when the first color component is a luminance component Y, the second color component may be a chrominance component U or a chrominance component V.

Using a YUV color space as an example, in this embodiment of this disclosure, for a current block having a YUV image format, a plurality of mapping relationships shown below may be obtained by fitting between a plurality of color components:
(1) A chrominance component U is predicted based on a luminance component Y, to obtain a mapping relationship U=f(Y).
(2) A chrominance component V is predicted based on a luminance component Y, to obtain a mapping relationship V=f(Y).
(3) A chrominance component Vis predicted based on a chrominance component U, to obtain a mapping relationship V=f(U).
(4) A chrominance component V is predicted based on a luminance component Y and a chrominance component U, to obtain a mapping relationship V=f(Y,U).
(5) A chrominance component U is predicted based on a luminance component Y and a chrominance component V, to obtain a mapping relationship U=f(Y,V).

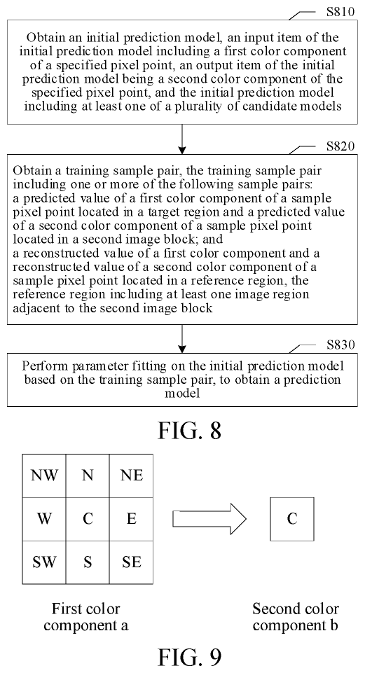

FIG. 8 is a flowchart of fitting a prediction model configured for representing a mapping relationship between color components according to an embodiment of this disclosure. As shown in FIG. 8, based on the foregoing embodiments, a prediction model obtaining method may include the following operations S810 to S830. In an example, the prediction model indicates the mapping relationship.

S810: Obtain an initial prediction model, an input (also referred to as an input item) of the initial prediction model including a first color component of a pixel (e.g., a specified pixel point), an output (also referred to as an output item) of the initial prediction model being a second color component of the specified pixel point, and the initial prediction model including at least one of a plurality of candidate models.

In an embodiment of this disclosure, the input item of the initial prediction model further includes a first color component of at least one neighborhood pixel point, and the neighborhood pixel point is a nearest or second nearest neighboring pixel point of the specified pixel point.

FIG. 9 is a schematic diagram of a relationship between a specified pixel point and a neighborhood pixel point according to an embodiment of this disclosure.

As shown in FIG. 9, C represents a specified pixel point, and specified pixel points in the first color component a and the second color component b may be pixel sample points at associated positions or at the same position.

Neighborhood pixel points of the specified pixel point C may include a plurality of nearest neighboring pixel points, for example, a plurality of pixel points N, S, W, and E that are respectively located at positions above, below, to the left of, and to the right of the specified pixel point C shown in FIG. 9.

The neighborhood pixel points of the specified pixel point C may include a plurality of second nearest neighboring pixel points, for example, a plurality of pixel points NW, NE, SW, and SE that are respectively located at positions to the upper left, upper right, lower left, and lower right of the specified pixel point C shown in FIG. 9.

Each time such a connection is established between the first color component a and the second color component b, which may be referred to as a cross-component matching pair, a mapping relationship equation may be generated. A plurality of such mapping relationship equations may be configured for solving a weighting parameter of a model. A position of the specified pixel point C in FIG. 9 is merely an example, and a pixel sample point in a larger range may alternatively be selected.

In an embodiment of this disclosure, the initial prediction model includes at least one combination item having an independent weighting parameter, and the combination item uses first color components of at least two pixel points as an input item.

The initial prediction model in this embodiment of this disclosure may include at least one monomial, and each monomial may have an independent weighting parameter. When first color components of at least two pixel points exist in one monomial as an input item, the monomial is referred to as a combination item.

In an embodiment of this disclosure, the initial prediction model may include at least two combination items of different orders, and the order is a highest power of the input item in the combination item. A nonlinear factor may be introduced through an exponentiation operation, to improve an effect of the model for fitting the color component mapping relationship.

In an embodiment of this disclosure, the initial prediction model may be obtained by performing a weighting operation on at least one of the following monomials: x, mx±ny, xy, x^{k}, (mx±ny)^{k}, (mx±ny)(pz±qf), (mx+ny)x, or B.

m, n, p, and q represent a weighting coefficient configured for fixedly weighting an input item; x, y, z, and f represent an input item, that is, a first color component of a specified pixel point or a neighborhood pixel point; B represents a constant bias term; and k represents an order of exponentiation operation performed on an input item, and k is an integer greater than 1.

In an embodiment of this disclosure, with reference to FIG. 9, the initial prediction model may include at least one of the following plurality of candidate models.

$$( 1 ) {C}_{b} = {p}_{0} C + {p}_{1} N + {p}_{2} S + {p}_{3} W + {p}_{4} E + {p}_{5} {C}^{2} + {p}_{6} B .$$

$$( 2 ) {C}_{b} = {p}_{0} C + {p}_{1} N + {p}_{2} S + {p}_{3} W + {p}_{4} E + {p}_{5} B .$$

$$( 3 ) {C}_{b} = {p}_{0} C + {p}_{1} B .$$

$$( 4 ) {C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} {C}^{2} + {p}_{6} B .$$

$$( 5 ) {C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} ( \frac{N + S}{2} ) ( \frac{W + E}{2} ) + {p}_{6} B .$$

$$( 6 ) {C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} {C}^{2} + {p}_{6} B .$$

$$( 7 ) {C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} ( \frac{N + S}{2} ) ( \frac{W + E}{2} ) + {p}_{6} B .$$

$$( 8 ) {C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} B .$$

$$( 9 ) {C}_{b} = {p}_{0} ( \frac{N + S + W + E}{4} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + W + E}{4} )}^{2} + {p}_{6} B .$$

$$( 10 ) {C}_{b} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B .$$

$$( 11 ) {C}_{b} = {p}_{0} C + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {p}_{5} {C}^{2} + {p}_{6} B .$$

$$( 12 ) {C}_{b} = {p}_{0} C + {p}_{1} S + {p}_{2} W + {p}_{3} E + {p}_{4} S W + {p}_{5} S E + {p}_{6} {C}^{2} + {p}_{7} B .$$

p₀, p₁, p₂, p₃, p₃, p₄, p₅, p₆, and p₇ represent weights.

S820: Obtain a training sample pair, the training sample pair including one or more of the following sample pairs:
a predicted value of a first color component of a sample pixel point (e.g., a pixel) located in the target region and a predicted value of a second color component of a sample pixel point located in the second image block; and
a reconstructed value of a first color component and a reconstructed value of a second color component of a sample pixel point located in the reference region, the reference region including at least one image region neighboring to the second image block.

In an embodiment of this disclosure, the mapping relationship between the first color component and the second color component may be fitted based on the predicted value of the color component of the second image block and the predicted value of the color component of the corresponding target region. In this case, the training sample pair configured for fitting the mapping relationship may include (the predicted value of the first color component of the sample pixel point located in the target region, the predicted value of the second color component of the sample pixel point located in the second image block).

In an embodiment of this disclosure, the predicted value of the first color component of the sample pixel point located in the target region and the predicted value of the second color component of the sample pixel point located in the second image block are obtained through prediction according to the preset prediction mode, and the preset prediction mode includes an intra prediction mode, an inter prediction mode, or an intra block copy prediction mode.

In an embodiment of this disclosure, the mapping relationship between the first color component and the second color component may be fitted based on the reconstructed value of the color component of the reference region. In this case, the training sample pair configured for fitting the mapping relationship may include (the reconstructed value of the first color component of the sample pixel point located in the reference region, the reconstructed value of the second color component of the sample pixel point).

In an embodiment of this disclosure, the mapping relationship between the first color component and the second color component may be fitted based on the predicted value of the color component of the second image block, the predicted value of the color component of the target region, and the reconstructed value of the color component of the reference region. In this case, the training sample pair configured for fitting the mapping relationship may include the foregoing two types, that is, (the predicted value of the first color component of the sample pixel point located in the target region, the predicted value of the second color component of the sample pixel point located in the second image block) and (the reconstructed value of the first color component of the sample pixel point located in the reference region, the reconstructed value of the second color component of the sample pixel point).

In an embodiment of this disclosure, a reference region corresponding to a current block (if not specifically described, a current block described below may represent a second image block. In an example, the current block described below represents the second image block unless specified otherwise) is formed by combining at least one nearest neighboring region or a second nearest neighboring region. The nearest neighboring region includes an image region that is located above or to the left of the current block and that has a specified image size, and the second nearest neighboring region includes an image region that is located to the upper left, lower left, or upper right of the current block and that has a specified size (also referred to as a specified image size).

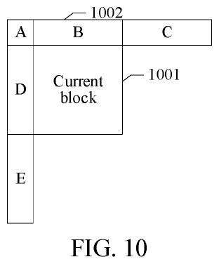

FIG. 10 is a schematic diagram of distribution of a reference region corresponding to a current block according to an embodiment of this disclosure.

As shown in FIG. 10, a reference region (also referred to as a template) corresponding to a current block 1001 may include a plurality of subregions 1002, and each subregion 1002 may be a nearest neighboring region or a second nearest neighboring region of the current block. The nearest neighboring region, for example, may include an image region B located above the current block 1001 or an image region D located to the left of the current block 1001. The second nearest neighboring region, for example, may include an image region A located to the upper left of the current block 1001, an image region E located to the lower left of the current block 1001, or an image region C located to the upper right of the current block 1001.

At least one of the image regions A to E is combined to form the reference region of the current block 1001.

In an embodiment of this disclosure, image sizes of subregions for forming the reference region are specified as follows: the second nearest neighboring region to the upper right of the second image block has a same image size as the second image block in a horizontal direction, and the second nearest neighboring region to the upper right of the second image block has a specified image size in a vertical direction;
the second nearest neighboring region to the lower left of the second image block has a same image size as the second image block in the vertical direction, and the second nearest neighboring region to the upper right of the second image block has a specified image size in the horizontal direction; and
the second nearest neighboring region to the upper left of the second image block has a specified image size in both the horizontal direction and the vertical direction.

In some examples, referring to FIG. 10, the nearest neighboring region B above the current block 1001 has the same image size as the current block 1001 in a horizontal direction, and the nearest neighboring region B above the current block 1001 has the specified image size in a vertical direction.

The nearest neighboring region D to the left of the current block 1001 has the same image size as the current block 1001 in the vertical direction, and the nearest neighboring region D to the left of the current block 1001 has the specified image size in the horizontal direction.

The second nearest neighboring region C to the upper right of the current block 1001 has the same image size as the current block 1001 in the horizontal direction, and the second nearest neighboring region to the upper right of the current block 1001 has the specified image size in the vertical direction.

The second nearest neighboring region E to the lower left of the current block 1001 has the same image size as the current block 1001 in the vertical direction, and the second nearest neighboring region E to the lower left of the current block 1001 has the specified image size in the horizontal direction.

The second nearest neighboring region A to the upper left of the current block 1001 has the specified image size in both the horizontal direction and the vertical direction.

A width and/or height in the specified image size may be a preset value greater than or equal to 1. For example, the width in the specified image size may be set to 6. When the width and/or height in the specified image size is greater than 1, color component prediction may be performed by using a plurality of layers of neighborhood pixel points, thereby improving accuracy of color component prediction.

In an embodiment of this disclosure, the subregions forming the reference region of the current block may have the same specified image size or different specified image sizes. For example, the size of the image region C in the vertical direction may be the same as or different from the size of the image region E in the horizontal direction.

In an embodiment of this disclosure, a pixel point on which decoding and reconstruction have been completed or a pixel point that is allowed may be selected from the subregion as a reference pixel point for performing color component prediction on the current block. For example, when decoding and reconstruction have been completed on a part of pixel points in the image region C, and decoding and reconstruction have not been completed on another part of pixel points in the image region C, the pixel points on which decoding and reconstruction have been completed may be selected from the image region C as reference pixel points for color component prediction in the current block.

In an embodiment of this disclosure, when a pixel point on which decoding and reconstruction have been performed in the subregion does not meet the foregoing size specification, the second nearest neighboring region may be configured to be unavailable. For example, when a lower right corner of the image region C is not reconstructed or extends outside an image boundary, the image region C may be configured to be unavailable. For another example, when a lower right corner of the image region E is not reconstructed or extend outside an image boundary, the image region E may be configured to be unavailable.

In an embodiment of this disclosure, all subregions shown in FIG. 10 may be combined to form the reference region of the current block, or some subregions may be combined to form the reference region of the current block.

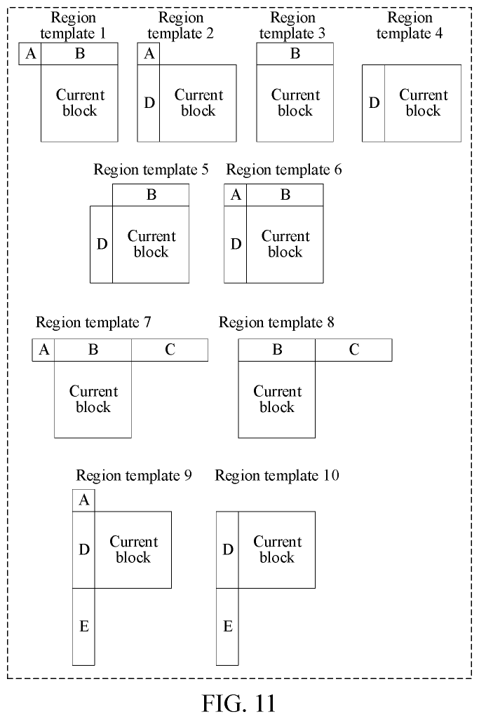

FIG. 11 is a schematic diagram of a region template of combining some subregions into a reference region according to an embodiment of this disclosure. As shown in FIG. 11, ten examples of candidate region templates may be formed based on a combination of different subregions. In this embodiment of this disclosure, one or more candidate region templates may be specified for the current block.

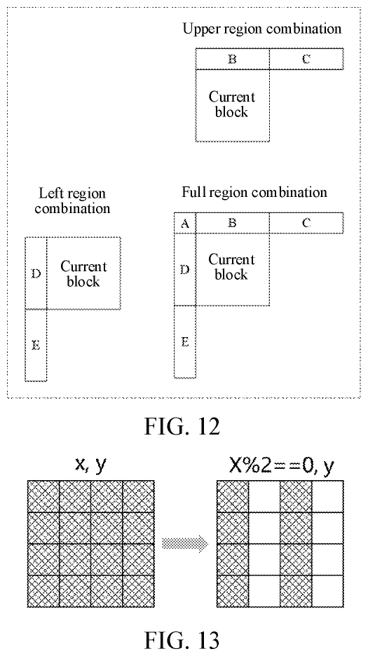

FIG. 12 is a schematic diagram of a region template of a reference region selected for a current block according to an embodiment of this disclosure. As shown in FIG. 12, in this embodiment of this disclosure, the reference region corresponding to the current block includes at least one of a full region combination, a left region combination, or an upper region combination.

The full region combination includes the nearest neighboring regions located to the left and above the current block and the second nearest neighboring region located to the upper left, lower left, and upper right of the current block.

The left region combination includes the nearest neighboring region located to the left of the current block and the second nearest neighboring region located to the lower left of the current block.

The upper region combination includes the nearest neighboring region located above the current block and the second nearest neighboring region located to the upper right of the current block.

In an embodiment of this disclosure, an indication field may be used in a video bitstream to mark the region template of the reference region used for the current block. For example, when a value of the indication field is 1, it represents that the reference region selected for the current block is the full region combination shown in FIG. 12; when the value of the indication field is 01, it represents that the reference region selected for the current block is the left region combination shown in FIG. 12; and when the value of the indication field is 00, it represents that the reference region selected for the current block is the upper region combination shown in FIG. 12.

In an embodiment of this disclosure, after the reference region used for performing color component prediction on the current block is determined, availability information of at least one subregion forming the reference region may be obtained, and then a region range of the reference region is adjusted based on the availability information of the at least one subregion.

In an embodiment of this disclosure, that the region range of the reference region is adjusted based on the availability information of the at least one subregion may further include: removing a subregion in an unavailable state from the reference region; and configuring the reference region to be in an unavailable state when all subregions in the reference region are in an unavailable state.

For example, the value of the indication field corresponding to the current block obtained by parsing the video bitstream is 1, which represents that the reference region used when color component prediction is performed on the current block is the full region combination including the five subregions A to E shown in FIG. 12.

When coding prediction is performed on the current block, availability information of each subregion in the reference region may be obtained, and the region range of the reference region may be adjusted based on the availability information.

For example, the subregions A, B, and C are image regions of other image blocks located above the current block. If encoding and reconstruction on the image blocks in which the subregions A, B, and C are located is not completed, the subregions A, B, and C are in an unavailable state. In this case, the region range of the reference region may be adjusted from A+B+C+D+E to D+E.

For another example, the subregions D and E are image regions of other image blocks located to the left of the current block. If encoding and reconstruction on the image blocks in which the subregions D and E are located is not encoded and reconstructed either, the subregions D and E are also in an unavailable state. In this case, the five subregions A to E are all in an unavailable state. Therefore, the entire reference region based on the full region combination may be configured to be in an unavailable state.

In an embodiment of this disclosure, sample pixel points used for training the prediction model may be all pixel points or some pixel points selected from the second image block and the at least one image region in the reference region. When some pixel points are selected to train the prediction model, pixel point sampling may be performed in the second image block and the at least one image region of the reference region according to a preset sampling rule.

In an embodiment of this disclosure, selecting the training sample pair from the second image block and the at least one image region of the reference region may include:
obtaining a pixel point sampling mode of the second image block, the pixel point sampling mode including full pixel point sampling or partial pixel point sampling,
when the pixel point sampling mode of the second image block is the full pixel point sampling, the sample pixel point located in the second image block being all pixel points in the second image block, and the sample pixel point located in the reference region being all pixel points in at least one image region in the reference region; or
when the pixel point sampling mode of the second image block is the partial pixel point sampling, the sample pixel point located in the second image block being some pixel points located at a specified sampling position, and the sample pixel point located in the reference region being some pixel points located at a specified sampling position in at least one image region in the reference region.

In an embodiment of this disclosure, the specified sampling position satisfies at least one of the following conditions.

First sampling position: coordinates of the specified sampling position satisfy a preset coordinate value condition.

In an embodiment of this disclosure, the coordinate value condition includes: at least one of a horizontal position coordinate or a vertical position coordinate of a pixel point is an even number; or at least one of a horizontal position coordinate or a vertical position coordinate of a pixel point is an odd number.

FIG. 13 is a schematic diagram of selecting a sampling position based on position coordinates of a pixel point according to an embodiment of this disclosure.

As shown in FIG. 13, in the reference region, a coordinate system is established with an upper left corner as a coordinate origin (0, 0), a horizontal position coordinate x represents a sequential position of a pixel point arranged from left to right in a horizontal direction, and a vertical position coordinate y represents a sequential position of a pixel point arranged from top to bottom in a vertical direction.

According to the preset coordinate value condition, even positions, odd positions, or all positions in the horizontal direction may be selected as specified sampling positions, or even positions, odd positions, or all positions in the vertical direction may be selected as specified sampling positions.

For example, in the embodiment shown in FIG. 13, pixel point positions at even positions (that is, X % 2==0) in the horizontal direction and at all positions in the vertical direction are selected as the specified sampling positions. That is, pixel point positions of a shadow part in the figure are selected as the specified sampling positions.

Second sampling position: the specified sampling position is selected in a preset pixel point scanning direction.

In an embodiment of this disclosure, pixel points in the reference region may be scanned in any scanning manner such as round-trip scanning or zigzag scanning, so as to sequentially select the specified sampling positions in the preset pixel point scanning direction and according to the preset sampling rule. The preset sampling rule may be, for example, interval sampling, that is, selecting a specified sampling position after every interval of at least one scanned pixel point.

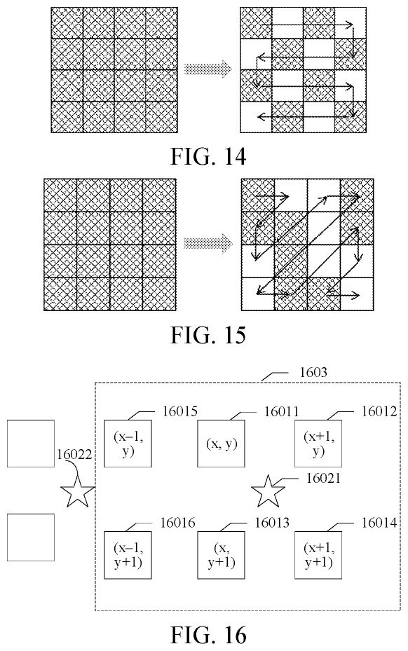

FIG. 14 is a schematic diagram of selecting a sampling position in a round-trip scanning manner according to an embodiment of this disclosure.

As shown in FIG. 14, one row of pixel points are scanned sequentially from left to right in the reference region, and after a boundary is reached, a next row of pixel points are scanned sequentially from right to left. In a pixel point scanning process, in the scanning direction, one specified sampling position is selected at intervals of one scanned pixel point. For example, an arrow shown in the figure indicates the scanning direction, and a pixel point position of a shadow part is a selected specified sampling position.

FIG. 15 is a schematic diagram of selecting a sampling position in a zigzag scanning manner according to an embodiment of this disclosure.

As shown in FIG. 15, pixel points are scanned from an upper left corner to a lower right corner in a zigzag scanning manner in the reference region. In a pixel point scanning process, in the scanning direction, one specified sampling position is selected at intervals of one scanned pixel point. For example, an arrow shown in the figure indicates the scanning direction, and a pixel point position of a shadow part is a selected specified sampling position.

Third sampling position: a reconstructed value of a first color component of a pixel point at the specified sampling position is within a preset value range.

Using an example in which the first color component is a luminance component, in this embodiment of this disclosure, a position at which a pixel point whose luminance value is greater than or less than a threshold is located may be selected as the specified sampling position.

For example, selecting sample pixel points with luminance values greater than a set threshold in the reference region may fit a prediction model, and selecting sample pixel points with luminance values less than or equal to the set threshold may fit another prediction model. During generation of a predicted image, a corresponding first prediction model may be used for the pixel point with the luminance value greater than the specified threshold, and a corresponding second prediction model may be used for the pixel point with the luminance value less than or equal to the specified threshold.

S830: Perform parameter fitting on the initial prediction model based on the training sample pair, to obtain the prediction model.

In an embodiment of this disclosure, the prediction model may fit a model parameter through online training or offline training.

The online training means performing training fitting in an encoding/decoding process of a current video frame. A model parameter may be calculated online during encoding/decoding of each current block.

The offline training means calculating a model parameter by offline fitting outside an encoding/decoding process. In an offline training process, the model parameter is trained offline based on a sample data set collected in advance. Then, a trained target prediction model is directly used during encoding/decoding, and the model parameter is no longer calculated in the encoding/decoding process of the current video frame. Compared with online training, offline training results in lower prediction accuracy of model prediction, but faster encoding and decoding speeds, making it suitable for application scenarios in which encoding and decoding quality requirements are lower but speed requirements are higher.

In an embodiment of this disclosure, in a process of training the prediction model, sampling may be performed in the current block and at least one image region of the reference region to obtain a plurality of sampling pixel points, and then parameter fitting is performed on the initial prediction model based on the first color component and the second color component of the sample pixel point to obtain the target prediction model.

For example, in this embodiment of this disclosure, the first color component and the second color component of the sampling pixel point may be inputted to the initial prediction model, to establish a plurality of equations, that is, Ax=b.

A is a matrix having M rows and N columns, where M and N respectively represent a quantity of equations established based on the initial prediction model and a quantity of model parameters in the initial prediction model, and x represents a parameter vector formed by using the model parameter in the initial prediction model as an element.

Values of all model parameters pᵢ can be obtained by solving the parameter vector x in the equation.

In an embodiment of this disclosure, an LDL decomposition method or a Gaussian elimination method may be selected to solve the equation. Using the LDL decomposition method as an example, solving operations may include:
(1) transform the equation into A^{T}Ax=A^{T}b;
(2) decompose A^{T}A, to obtain LDL^{T}x=A^{T}b;
(3) solve LY=A^{T}b to obtain a matrix Y; and
(4) solve DL^{T}x=Y to obtain the parameter vector x, to obtain the model parameter pᵢ.

In an embodiment of this disclosure, when the luminance component Y is selected as the first color component and the chrominance component U and the chrominance component V are selected as the second color component, that is, the chrominance component U and the chrominance component V are predicted based on the luminance component Y, since in both the prediction processes, A^{T}A needs to be decomposed, processes of decomposing A^{T}A in two chrominance component prediction processes may be merged, to reduce calculation complexity and improve encoding/decoding efficiency.

Based on the fitted target prediction model, the reconstructed value of the first color component of the target region may be inputted to the target prediction model as an input item, and the target prediction model outputs the predicted value of the second color component of the second image block.

In an embodiment of this disclosure, the color component prediction solution provided in the foregoing embodiments may be performed on a part of image blocks in the current video frame, and the color component prediction solution provided in the foregoing embodiments is prohibited from being performed on another part of image blocks. Based on this, a prediction condition corresponding to the image block may be explicitly or implicitly marked, and the color component prediction method for predicting the second color component based on the first color component is performed when the prediction condition is satisfied.

In an embodiment of this disclosure, when the first image block and the second image block have the same partitioning tree structure, the prediction condition includes: a quantity of non-zero coefficients of the first color component of the target region is greater than a preset quantity threshold.

The non-zero coefficient of the first color component is a quantization coefficient whose value is not zero in quantization coefficients of the first color component in the first image block. The quantity threshold may be a preset default value, or may be obtained by parsing a video stream or implicit exportation.

For example, when the chrominance block and the luminance block have the same partitioning tree structure, that is, in a merge tree mode, if the quantity of non-zero coefficients in the luminance block corresponding to the chrominance block is greater than or equal to a specified threshold, the luminance component is allowed for predicting the chrominance component; otherwise, the luminance component is prohibited for predicting the chrominance component.

In another embodiment of this disclosure, when the first image block and the second image block have different partitioning tree structures, the prediction condition includes one or more of the following conditions: a quantity of non-zero coefficients of the first color component of the target region is greater than a preset quantity threshold; and a sum of quantities of non-zero coefficients of first color components of a plurality of first image blocks corresponding to the target region is greater than a preset quantity threshold.

When the chrominance block and the luminance block have different partitioning tree structures, that is, in a separate tree mode, if the quantity of non-zero coefficients in a luminance region corresponding to the chrominance block (that is, a partial region or an entire region in the at least one luminance block corresponding to the chrominance block) is greater than or equal to a specified threshold, the luminance component is allowed for predicting the chrominance component; otherwise, the luminance component is prohibited for predicting the chrominance component.

For another example, when the chrominance block and the luminance block have different partitioning tree structures, that is, in a separate tree mode, if a sum of quantities of non-zero coefficients in all luminance blocks in which a luminance region corresponding to the chrominance block is located is greater than or equal to a specified threshold, the luminance component is allowed for predicting the chrominance component; otherwise, the luminance component is prohibited for predicting the chrominance component.

In an embodiment of this disclosure, the prediction condition includes one or more of the following conditions: the first image block and the second image block have the same partitioning tree structure, and the quantity of non-zero coefficients of the first color component of the target region is greater than the preset quantity threshold; or the first image block and the second image block have different partitioning tree structures.

For example, in a case of a luminance-chrominance merge tree, if the quantity of non-zero coefficients in the luminance block corresponding to the chrominance block is greater than or equal to 3, cross-component prediction is allowed; otherwise, the cross-component prediction is prohibited. In a case of a luminance-chrominance separate tree, cross-component prediction may be used without being limited by the quantity of non-zero coefficients in the corresponding luminance block.

In an embodiment of this disclosure, the prediction condition may further include at least one of the following five conditions.

First prediction condition: predicting the second image block by using a preset prediction mode, where the prediction mode includes one or more of an intra prediction mode, an inter prediction mode, and an intra block copy prediction mode.

Second prediction condition: an index corresponding to the second image block has a specified index value, and the index indicates whether to perform: mapping the reconstructed value of the first color component, to obtain the predicted value of the second color component of the second image block.

For example, for a second image block, an index may be decoded in a sequence header/an image header/a slice header/a largest coding block. The index indicates whether the cross-component prediction method for predicting the second color component based on the first color component is performed on all image blocks in the current sequence/image/slice/largest coding block.

Third prediction condition: an image feature of the target region satisfies a preset first feature condition.

In an embodiment of this disclosure, the first feature condition includes: a reconstruction parameter of the first color component of the target region is within a preset value range.

In an embodiment of this disclosure, the preset value range includes being greater than zero or being less than zero.

For example, the reconstruction parameter is the foregoing reconstructed residual signal, which is referred to as a reconstructed residual for short. For a second image block, the cross-component prediction method for predicting a second color component based on the first color component is performed on the second image block only when a reconstructed residual of the first color component of the target region corresponding to the second image block is greater than zero or less than zero. When the reconstructed residual of the first color component of the target region is equal to zero, the cross-component prediction operation of predicting the second color component based on the first color component may be skipped.

Fourth color component prediction condition: an image feature of the second image block satisfies a preset second feature condition.

In an embodiment of this disclosure, the second feature condition may include: an image size of the second image block is within a preset size range; or the position of the second image block in the current video frame is within a specified region range.

In an implementation, whether the cross-component prediction method for predicting the second color component based on the first color component is performed on the second image block may be indicated by whether the image size of the second image block meets a preset range limit.

In an implementation, whether the cross-component prediction method for predicting the second color component based on the first color component is performed on the second image block may be indicated by whether the position of the second image block meets a preset range limit. For example, if the second image block is located at an upper left corner of the current video frame, the cross-component prediction method for predicting the second color component based on the first color component is not performed.

Fifth color component prediction condition: an image feature of a reference region corresponding to the second image block satisfies a preset third feature condition, where the reference region includes at least one image region adjacent to the second image block.

In an embodiment of this disclosure, the third feature condition includes: a region area of the reference region corresponding to the second image block is greater than a preset area threshold; or a quantity of pixels at a specified sampling position in the reference region corresponding to the second image block is greater than a preset quantity threshold. The preset quantity threshold may be a quantity of model parameters in the prediction model.

In an implementation, the cross-component prediction method for predicting the second color component based on the first color component is performed on the second image block only when a region area of the reference region is greater than a specified area threshold.

In an implementation, the cross-component prediction method for predicting the second color component based on the first color component is performed on the second image block only when the quantity of pixels at the specified sampling position in the reference region (that is, a quantity of pixels included in a matching pair of the first color component and the second color component) is greater than the quantity of model parameters in the prediction model.

In an embodiment of this disclosure, before the mapping is performed on the reconstructed value of the first color component of the target region based on the mapping relationship, downsampling may be first performed on the first color component, to obtain the first color component that can form a matching pair with the second color component.

Using the image block in the YUV format shown in FIG. 5B as an example, when the first color component is the luminance component Y, and the second color component is the chrominance component U or the chrominance component V, luminance blocks and chrominance blocks obtained after color component sampling is performed according to a sampling format in 420 have different block sizes. In the horizontal direction and the vertical direction, a resolution of a luminance component is twice that of a chrominance component. In this case, to form a matching pair between the luminance component and the chrominance component, downsampling may be performed on the luminance component.

In an embodiment of this disclosure, a method for downsampling the first color component may include: determining a sampling window having a specified window size based on a pixel point position of the second color component of the second image block; and downsampling the reconstructed value of the first color component of the target region in the sampling window, to obtain a reconstructed value of a first color component matching the pixel point position. During mapping of the reconstructed value of the first color component of the target region, the reconstructed value of the matched first color component may be mapped, to obtain the predicted value of the second color component of the second image block. In an example, the reconstructed samples that are within the sampling window of the target region are downsampled to obtain downsampled samples in the target region. The reconstructed samples that are within the sampling window include the at least one of the reconstructed samples in the target region. One of the downsampled samples in the target region corresponds to the sample in the second coding block. The predicted value of the sample in the second coding block is obtained based on the downsampled samples in the target region. In an example, the mapping relationship indicates a relationship between one or more of the downsampled samples in the target region and the value of the sample in the second coding block. The predicted value of the sample in the second coding block is obtained based on the one or more of the downsampled samples in the target region.

In an embodiment of this disclosure, the sampling window determined based on the pixel point position of the second color component is configured to cover four first color components that are nearest neighboring and two first color components that are second nearest neighboring and that are located to the left.

FIG. 16 is a schematic diagram of a sampling window of downsampling a first color component according to an embodiment of this disclosure.

As shown in FIG. 16, squares distributed in a form of an array represent first color components, including 16011 to 16016, and five-pointed stars distributed in the array represent second color components, including 16021 and 16022. In this embodiment of this disclosure, a sampling window 1603 with a specified window size corresponding to the second color component 16021 may be determined based on a pixel point position of the second color component 16021. The sampling window 1603 can cover four the first color components 16011 to 16014 that are nearest neighboring to the second color component 16021 and two first color components 16015 and 16016 that are second nearest neighboring and that are to the left.

In an embodiment of this disclosure, the downsampling the reconstructed value of the first color component of the target region in the sampling window, to obtain a reconstructed value of a first color component matching the pixel point position includes: obtaining, in the sampling window, a correspondence between the reconstructed value of the first color component of the target region and the pixel point position; and performing a weighting operation on the reconstructed value of the first color component of the target region based on the correspondence, to obtain the reconstructed value of the first color component matching the pixel point position.

For example, in this embodiment of this disclosure, downsampling may be performed on the reconstructed value of the first color component according to the following formula:

$${L}^{′} ( x , y ) = ( L ( x - 1 , y ) + 2 L ( x , y ) + L ( x + 1 , y ) + L ( x - 1 , y + 1 ) + 2 L ( x , y + 1 ) + L ( x + 1 , y + 1 ) ) / 8$$

L and L′ respectively represent an original reconstructed value of a first color component and a reconstructed value of a first color component obtained after downsampling. x and y respectively represent a horizontal position coordinate and a vertical position coordinate of the first color component. Using the sampling window shown in FIG. 16 as an example, coordinates of the two first color components 16011 and 16013 that are nearest neighboring and that are located to the left of the second color component 16021 are (x, y) and (x, y+1), and a weight coefficient ¼ may be assigned. Coordinates of the other four first color components 16012 and 16014 to 16016 are (x−1, y), (x−1, y+1), (x+1, y), and (x+1, y+1), and a weight coefficient ⅛ may be assigned. In an example, the one (e.g., L′(x, y)) of the downsampled samples in the target region is determined based on a weighted summation of a plurality of the reconstructed samples (e.g., the plurality of the reconstructed samples having the coordinates at (x, y), (x, y+1), (x−1, y), (x−1, y+1), (x+1, y), and (x+1, y+1)) that are within the sampling window, such as shown in the above formula for L′ (x, y).

In an embodiment of this disclosure, when the two first color components 16015 and 16016 that are second nearest neighboring and that are located to the left are unavailable, that is, the two first color components whose coordinates are (x−1, y) and (x−1, y+1) are unavailable, the two first color components 16011 and 16013 that are nearest neighboring and that are located to the left may be used for replacement, that is, the first color components whose coordinates are (x, y) and (x, y+1) are used for replacement.

In an embodiment of this disclosure, during training of the prediction model, when the first color component of the target region is selected to be downsampled, the first color component used as a model training sample may be synchronously downsampled in at least one image region in the reference region. That is, the sampling window having the specified window size is determined based on the pixel point position of the second color component of the second image block in at least one image region in the reference region, where the reference region includes at least one image region adjacent to the second image block; and a reconstructed value of a first color component of the at least one image region is downsampled in the sampling window, to obtain the reconstructed value of the first color component matching the pixel point position.

In an embodiment of this disclosure, the first color component may be selected to be downsampled; or downsampling may not be performed, and a first color component at a position that is the same as or corresponds to a position of the second color component is selected for performing color component prediction. Using FIG. 16 as an example, a first color component 1601 that corresponds to a second color component 1602 and whose position coordinates are (x, y) may be selected for performing color component prediction.

In an embodiment of this disclosure, when the sampling format of the first color component is the same as that of the second color component, before the color component prediction is performed on the first color component by using the prediction model, the first color component may be first filtered, to reduce redundant information or interference information in the first color component, thereby further improving prediction accuracy of the second color component, that is, improving video encoding/decoding accuracy of the second image block.

Based on this, during fitting of the prediction model, a plurality of filters may be simultaneously selected to perform filtering on sample data of the first color component, so that different first color component samples may be selected for training and fitting the prediction model, thereby improving a fitting training effect of the prediction model.

In an embodiment of this disclosure, after downsampling or filtering is performed on the first color component, boundary extension may be performed on a pixel point position of the first color component based on a requirement, to obtain a neighborhood pixel point configured for the specified pixel point.

A plurality of different cross-component prediction solutions are described in the foregoing embodiments. For example, the reference region includes a plurality of different candidate region templates, and the prediction model also includes a plurality of different candidate prediction models. A plurality of different color component prediction solutions may be obtained by combining the plurality of different candidate region templates and the plurality of different candidate prediction models.

For different image blocks, the same cross-component prediction solution or different cross-component prediction solutions may be selected for use.

In an embodiment of this disclosure, for example, for image blocks having different block sizes, different color component prediction solutions (candidate region templates and candidate prediction models) may be used.

In an embodiment of this disclosure, a color component prediction solution used for a current block may be indicated in a data stream by using an explicit index or an implicit index. For example, the candidate region template and/or the candidate prediction model used for the current block may be indicated by using one index or a combination of a plurality of indexes.

In an embodiment of this disclosure, a plurality of different color component prediction solutions may be used for a current block, and then a weighting operation is performed on prediction results of the plurality of solutions, to obtain a final color component prediction result.

In an embodiment of this disclosure, a final predicted image may be obtained by weighting a cross-component prediction result provided in the foregoing embodiments and a prediction result of a prediction mode such as an intra prediction mode, an inter prediction mode, or an intra block copy prediction mode.

In an embodiment of this disclosure, the intra prediction, the inter prediction, or a block-vector (BV) based prediction (e.g., the intra block copy prediction) is performed on the second image block according to the preset prediction mode (e.g., a second prediction mode), to obtain an initial predicted value (e.g., a second value of the sample in the second coding block) of the second color component of the second image block; and after the reconstructed value of the first color component of the target region is mapped based on the mapping relationship, to obtain the predicted value of the second color component of the second image block, the weighting operation is performed on the initial predicted value and the predicted value of the second color component based on a preset weight coefficient, to obtain an updated predicted value of the second color component.

For example, in this embodiment of this disclosure, the final prediction result pred of the second color component of the second image block may be determined according to the following formula.

$$pred = w * {pred}_{1} + ( 1 - w ) * {pred}_{2}$$

pred₁ represents a predicted value of a second color component obtained through prediction based on a first color component according to the solution provided in any of the foregoing embodiments, pred₂ represents an initial predicted value of a second color component obtained through prediction according to an intra prediction mode, an inter prediction mode, or an intra block copy prediction mode, and w represents a weight coefficient for performing a weighting operation on the two prediction results. In an example, the second value pred₂ of the sample in the second coding block is predicted according to the second prediction mode. The second prediction mode includes one of: the intra prediction mode, the inter prediction mode, or the BV based prediction mode (e.g., the intra block copy prediction mode). A weighted average of the second predicted value pred₂ and the predicted value pred₁ (e.g., obtained using the mapping relationship) of the second coding block is determined based on the weight coefficient w to obtain the updated value pred of the sample in the second coding block.

An implementation process of this embodiment of this disclosure in an actual application scenario is described below.

In the application scenario, a luminance component Y corresponding to a luminance block is predicted by using an inter prediction mode or an intra block copy prediction mode, to obtain a reconstructed value of a luminance component of the luminance block (that is, the reconstructed value of the first color component of the target region), and then a chrominance component U and a chrominance component V are respectively predicted by using the luminance component Y.

With reference to FIG. 9, a used prediction model is as follows:

$${C}_{b} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B$$

In the application scenario, the reference region corresponding to the current block is used for training the prediction model, that is, a pixel point in the reference region is selected as a sample pixel point for training the prediction model. Correspondingly, the training sample pair includes a reconstructed value of a luminance component and a reconstructed value of a chrominance component of the sample pixel point in the reference region.

A plurality of nearest neighboring or second nearest neighboring image regions of the current block shown in FIG. 10 may be selected as the reference region. That is, two nearest neighboring regions located above and to the left of the current block and three second nearest neighboring regions located to the upper left, lower left, and upper right of the current block are selected.

Then, the reconstructed value of the luminance block and a reconstructed value of a luminance component of the reference region may be downsampled. For example, the sampling window shown in FIG. 16 may be used. A downsampling process is as follows:

$${L}^{′} ( x , y ) = ( L ( x - 1 , y ) + 2 L ( x , y ) + L ( x + 1 , y ) + L ( x - 1 , y + 1 ) + 2 L ( x , y + 1 ) + L ( x + 1 , y + 1 ) ) / 8$$

After downsampling of the reconstructed value of the luminance component is completed, a pixel whose position coordinates are not an odd number in the horizontal direction or the vertical direction is selected from the reference region as a sample pixel point, to construct a sample pair including a reconstructed value of a luminance component and a reconstructed value of chrominance component. In another implementation, alternatively, a pixel whose at least one position coordinate in the horizontal direction or the vertical direction is an even number may be selected as a sample pixel point in the reference region.

The sample pair is inputted to the prediction model, an equation is established, and then each model parameter pᵢ in the prediction model is solved, where i=0, . . . , 6. A first prediction model for predicting the chrominance component U based on the luminance component Y and a second prediction model for predicting the chrominance component V based on the luminance component Y are respectively obtained.

After downsampling, the reconstructed value of the luminance component in the luminance block is separately inputted to the first prediction model and the second prediction model that are subjected to fitting training, to obtain prediction results of the chrominance component U and the chrominance component V.

If the current prediction mode is the inter prediction mode or the intra block copy prediction mode, the weighting operation is separately performed on the prediction results of the chrominance component U and the chrominance component V and the initial prediction result according to the following formulas, to obtain final prediction results pred of the chrominance component U and the chrominance component V. The initial prediction results include a prediction result of inter prediction or a prediction result of intra block copy.

$$pred = w * {pred}_{1} + ( 1 - w ) * {pred}_{2}$$

pred₁ represents a predicted value of a chrominance component U or a chrominance component V obtained through prediction based on a luminance component Y, pred₂ represents an initial predicted value of a chrominance component U or a chrominance component V obtained through prediction according to an inter prediction mode or an intra block copy prediction mode, and w represents a weight coefficient for performing a weighting operation on the two prediction results. For example, the weight coefficient may be 0.75.

In the application scenario, the luminance-chrominance merge tree or the luminance-chrominance separate tree is allowed to use the cross-component prediction solution provided in this embodiment of this disclosure. In a case of the luminance-chrominance merge tree, if a quantity of non-zero coefficients of a luminance block corresponding to chrominance is greater than or equal to 3, cross-component prediction is allowed; otherwise, cross-component prediction is prohibited. The luminance-chrominance separate tree is not limited by a quantity of non-zero coefficients corresponding to a luminance block.

It can be known based on the foregoing embodiments and descriptions of disclosure scenarios that the embodiments of this disclosure provide a cross-component color component prediction method. A cross-component prediction model is generated based on a predicted image of an adjacent reconstructed pixel or a current block by using a similarity between mapping relationships between components of an adjacent region or a predicted image and a reconstructed image, and then a target predicted image of a current image block is generated by using a cross-component prediction model. Compared with an encoding and prediction solution in related technologies, in the embodiments of this disclosure, prediction precision of the color component can be further improved by using a reconstructed pixel of the current block, thereby improving encoding/decoding efficiency. In addition, a use range of cross-component prediction is expanded in the embodiments of this disclosure. That is, a cross-component color component prediction solution may also be used in a luminance-chrominance separate tree mode. In addition, cross-component prediction is not allowed when a quantity of non-zero luminance coefficients at a corresponding position of a chrominance block is relatively small, thereby reducing a bit rate and improving the encoding/decoding efficiency.

In an example, the current coding block is predicted based on the cross-component prediction model. The cross-component prediction model is applied within the current block region to generate the prediction of the current coding block. If the current coding block is selected as the template, the prediction of the input component (downsampled) and the prediction of the target component of the current block are selected to construct the cross-component prediction model. If downsampling has been performed on the prediction of the input component, the same downsampling is applied to the reconstruction of the input component. The reconstruction (downsampled) of the input component of the current block is fed into the cross-component prediction model to generate the prediction of the target component.

The operations of the method of this disclosure are described in a specific order in the accompanying drawings. However, this does not request or imply that the operations are performed according to the specific order, or all shown operations are necessarily performed to implement a desired result. Additionally or alternatively, some operations may be omitted, a plurality of operations may be combined into one operation for execution, and/or one operation may be decomposed into a plurality of operations for execution.

The following describes an apparatus embodiment of this disclosure, and the apparatus may be configured to perform the video encoding/decoding method in the foregoing embodiments of this disclosure. In an aspect, an image processing apparatus includes processing circuitry. The processing circuitry is configured to determine, based on a position of a second coding block in a coding unit in a current picture, a target region of the second coding block, the target region being associated with at least one first coding block. The coding unit includes the at least one first coding block in a first color component and the second coding block in a second color component. The processing circuitry is configured to determine reconstructed samples in the target region according to a prediction mode. The processing circuitry is configured to predict a value of a sample in the second coding block based on at least one of the reconstructed samples in the target region and a mapping relationship between the at least one of the reconstructed samples in the target region of the first color component and the value of the sample in the second coding block of the second color component in response to one of (i) a number of non-zero coefficients in the target region of the first color component or (ii) a number of non-zero coefficients in the at least one first coding block of the first color component being greater than a threshold.

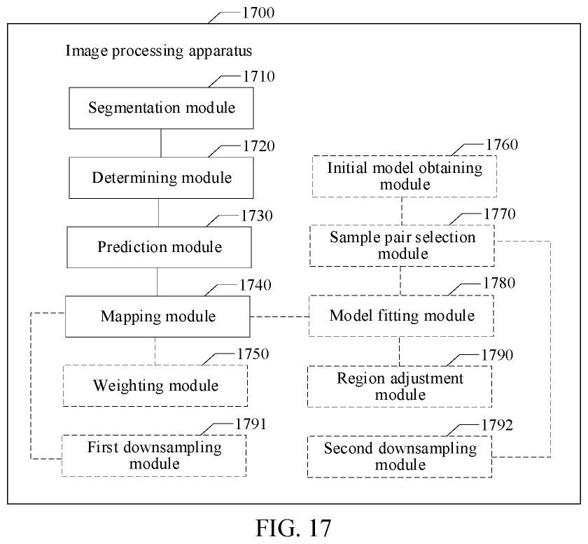

FIG. 17 is a structural block diagram of an image processing apparatus according to an embodiment of this disclosure. As shown in FIG. 17, the image processing apparatus 1700 may include:
a segmentation module 1710, configured to segment a current video frame, to obtain at least one first image block and a second image block, the first image block being a coding unit having a first color component, and the second image block being a coding unit having a second color component;
a determining module 1720, configured to determine, based on a position of the second image block in the current video frame, a coding region associated with the position in the at least one first image block as a target region;
a prediction module 1730, configured to obtain a reconstructed value of a first color component of the target region through prediction according to a preset prediction mode; and
a mapping module 1740, configured to map the reconstructed value of the first color component of the target region based on a mapping relationship between the first color component and the second color component in response to that a preset prediction condition is satisfied, to obtain a predicted value of the second color component of the second image block.

In an embodiment of this disclosure, the segmentation module 1710 is configured to segment the current video frame based on a single partitioning tree structure, to obtain the at least one first image block and the second image block; and
the determining module 1720 is configured to determine, based on the position, an entire region of one first image block corresponding to the second image block in the at least one first image block as the target region.

In an embodiment of this disclosure, the segmentation module 1710 is configured to segment the current video frame based on a first partitioning tree structure, to obtain the at least one first image block; and segment the current video frame based on a second partitioning tree structure, to obtain the second image block; and
the determining module 1720 is configured to determine, based on the position, a partial or an entire region corresponding to the second image block in the at least one first image block as the target region.

In an embodiment of this disclosure, the prediction condition includes: a quantity of non-zero coefficients of the first color component of the target region is greater than a preset quantity threshold.

In an embodiment of this disclosure, the prediction condition includes one or more of the following conditions:
the first partitioning tree structure is different from the second partitioning tree structure;
a quantity of non-zero coefficients of the first color component of the target region is greater than a preset quantity threshold; and
a sum of quantities of non-zero coefficients of first color components of a plurality of first image blocks corresponding to the target region is greater than a preset quantity threshold.

In an embodiment of this disclosure, the prediction condition includes one or more of the following conditions:
an index corresponding to the second image block has a specified index value, and the index indicates whether to perform: mapping the reconstructed value of the first color component, to obtain the predicted value of the second color component of the second image block;
an image feature of the target region satisfies a preset first feature condition;
an image feature of the second image block satisfies a preset second feature condition; and
an image feature of a reference region corresponding to the second image block satisfies a preset third feature condition, the reference region including at least one image region adjacent to the second image block.

In an embodiment of this disclosure, the first feature condition includes: a reconstruction parameter of the first color component of the target region is within a preset value range.

In an embodiment of this disclosure, the second feature condition includes one or more of the following conditions:
an image size of the second image block is within a preset size range; and
the position of the second image block in the current video frame is within a specified region range.

The third feature condition includes one or more of the following conditions:
a region area of the reference region corresponding to the second image block is greater than a preset area threshold; and
a quantity of pixels at a specified sampling position in the reference region corresponding to the second image block is greater than a preset quantity threshold.

In an embodiment of this disclosure, the mapping relationship is represented by a prediction model, and the quantity threshold is a quantity of model parameters in the prediction model.

In an embodiment of this disclosure, the image processing apparatus 1700 further includes:
a weighting module 1750, configured to obtain an initial predicted value of the second color component of the second image block through prediction according to the preset prediction mode, the prediction mode including an intra prediction mode, an inter prediction mode, or an intra block copy prediction mode; and
perform a weighting operation on the initial predicted value and the predicted value of the second color component based on a preset weight coefficient, to obtain an updated predicted value of the second color component.

In an embodiment of this disclosure, the mapping relationship is represented by the prediction model, and the image processing apparatus 1700 further includes:
an initial model obtaining module 1760, configured to obtain an initial prediction model, an input item of the initial prediction model including a first color component of a specified pixel point, an output item of the initial prediction model being a second color component of the specified pixel point, and the initial prediction model including at least one of a plurality of candidate models;
a sample pair selection module 1770, configured to obtain a training sample pair, the training sample pair including one or more of the following sample pairs:
   a predicted value of a first color component of a sample pixel point located in the target region and a predicted value of a second color component of a sample pixel point located in the second image block; and
   a reconstructed value of a first color component and a reconstructed value of a second color component of a sample pixel point located in the reference region, the reference region including at least one image region adjacent to the second image block; and
a model fitting module 1780, configured to perform parameter fitting on the initial prediction model based on the training sample pair, to obtain the prediction model.

In an embodiment of this disclosure, the predicted value of the first color component of the sample pixel point located in the target region and the predicted value of the second color component of the sample pixel point located in the second image block are obtained through prediction according to the preset prediction mode, and the prediction mode includes the intra prediction mode, the inter prediction mode, or the intra block copy prediction mode.

In an embodiment of this disclosure, the input item of the initial prediction model further includes a first color component of at least one neighborhood pixel point, and the neighborhood pixel point is a nearest or second nearest neighboring pixel point of the specified pixel point.

In an embodiment of this disclosure, the initial prediction model includes at least one combination item having an independent weighting parameter, and the combination item uses first color components of at least two pixel points as an input item.

In an embodiment of this disclosure, the initial prediction model includes at least two combination items of different orders, and the order is a highest power of the input item in the combination item.

In an embodiment of this disclosure, the reference region is formed by combining at least one nearest neighboring region or second nearest neighboring region, the nearest neighboring region includes an image region that is located above or to the left of the second image block and that has a specified image size, and the second nearest neighboring region includes an image region that is located to the upper left, lower left, or upper right of the second image block and that has a specified image size.

In an embodiment of this disclosure, the second nearest neighboring region to the upper right of the second image block has a same image size as the second image block in a horizontal direction, and the second nearest neighboring region to the upper right of the second image block has a specified image size in a vertical direction;
the second nearest neighboring region to the lower left of the second image block has a same image size as the second image block in the vertical direction, and the second nearest neighboring region to the upper right of the second image block has a specified image size in the horizontal direction; and
the second nearest neighboring region to the upper left of the second image block has a specified image size in both the horizontal direction and the vertical direction.

In an embodiment of this disclosure, the reference region includes at least one of a full region combination, a left region combination, and an upper region combination,
the full region combination including the nearest neighboring regions located to the left of and above the second image block and the second nearest neighboring region located to the upper left, lower left, and upper right of the second image block;
the left region combination including the nearest neighboring region located to the left of the second image block and the second nearest neighboring region located to the lower left of the second image block; and
the upper region combination including the nearest neighboring region located above the second image block and the second nearest neighboring region located to the upper right of the second image block.

In an embodiment of this disclosure, the image processing apparatus 1700 further includes:
a region adjustment module 1790, configured to obtain availability information of at least one subregion forming the reference region; and adjust a region range of the reference region based on the availability information.

In an embodiment of this disclosure, the region adjustment module 1790 is configured to remove a subregion in an unavailable state from the reference region; and configure the reference region to be in an unavailable state when all subregions in the reference region are in an unavailable state.

In an embodiment of this disclosure, the sample pair obtaining module 1770 is configured to: obtain a pixel point sampling mode of the second image block, the pixel point sampling mode including full pixel point sampling or partial pixel point sampling,
when the pixel point sampling mode of the second image block is the full pixel point sampling, the sample pixel point located in the second image block being all pixel points in the second image block, and the sample pixel point located in the reference region being all pixel points in at least one image region in the reference region; or
when the pixel point sampling mode of the second image block is the partial pixel point sampling, the sample pixel point located in the second image block being some pixel points located at a specified sampling position, and the sample pixel point located in the reference region being some pixel points located at a specified sampling position in at least one image region in the reference region.

In an embodiment of this disclosure, the specified sampling position satisfies at least one of the following conditions:
coordinates of the specified sampling position satisfy a preset coordinate value condition;
selecting the specified sampling position in a preset pixel point scanning direction; or
a reconstructed value of a first color component of a pixel point at the specified sampling position is within a preset value range.

In an embodiment of this disclosure, the coordinate value condition includes:
at least one of a horizontal position coordinate or a vertical position coordinate is an even number; or
at least one of a horizontal position coordinate or a vertical position coordinate is an odd number.

In an embodiment of this disclosure, the image processing apparatus 1700 further includes:
a first downsampling module 1791, configured to determine a sampling window having a specified window size based on a pixel point position of the second color component of the second image block; and downsample the reconstructed value of the first color component of the target region in the sampling window, to obtain a reconstructed value of a first color component matching the pixel point position; and
the mapping module 1740 is configured to map the reconstructed value of the matched first color component, to obtain the predicted value of the second color component of the second image block.

In an embodiment of this disclosure, the first downsampling module 1791 is configured to: obtain, in the sampling window, a correspondence between the reconstructed value of the first color component of the target region and the pixel point position; and
perform a weighting operation on the reconstructed value of the first color component of the target region based on the correspondence, to obtain the reconstructed value of the first color component matching the pixel point position.

In an embodiment of this disclosure, the image processing apparatus 1700 further includes:
a second downsampling module 1792, configured to: determine the sampling window having the specified window size based on the pixel point position of the second color component of the second image block in at least one image region in the reference region corresponding to the second image block; and downsample a reconstructed value of a first color component of the at least one image region in the sampling window, to obtain the reconstructed value of the first color component matching the pixel point position.

Details of a video decoding apparatus and a video encoding apparatus provided in the embodiments of this disclosure are described in further detail in the corresponding method embodiments and are not described herein again.

In an aspect, the disclosure describes a non-transitory computer-readable storage medium storing instructions which when executed by a processor cause the processor to perform a method of encoding a bitstream. The method includes determining, based on a position of a second coding block in a coding unit in a current picture, a target region of the second coding block. The target region is associated with at least one first coding block. The coding unit includes the at least one first coding block in a first color component and the second coding block in a second color component. The method includes determining reconstructed samples in the target region according to a prediction mode. The method includes predicting a value of a sample in the second coding block based on at least one of the reconstructed samples in the target region and a mapping relationship between the at least one of the reconstructed samples in the target region of the first color component and the value of the sample in the second coding block of the second color component in response to one of (i) a number of non-zero coefficients in the target region of the first color component or (ii) a number of non-zero coefficients in the at least one first coding block of the first color component being greater than a threshold.

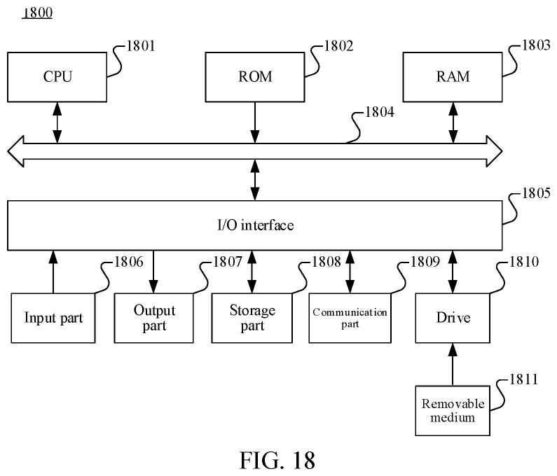

FIG. 18 is a structural block diagram of an electronic device configured to implement the embodiments of this disclosure.

An electronic device 1800 shown in FIG. 18 is merely an example, and does not constitute any limitation on functions and usage scope of the embodiments of this disclosure.

As shown in FIG. 18, the electronic device 1800 includes a central processing unit (CPU) 1801, which may perform various suitable actions and processing based on a program stored in a read-only memory (ROM) 1802 or a program loaded from a storage part 1808 into a random access memory (RAM) 1803. The random access memory 1803 further has various programs and data required for system operation stored therein. The central processing unit 1801, the read-only memory 1802, and the random access memory 1803 are connected to each other through a bus 1804. An input/output interface (I/O interface) 1805 is also connected to the bus 1804.

The following components are connected to the input/output interface 1805: an input part 1806 including a keyboard, a mouse, and the like; an output part 1807 including a cathode ray tube (CRT), a liquid crystal display (LCD), a loudspeaker, and the like; the storage part 1808 including a hard disk, and the like; and a communication part 1809 including a network interface card such as a local area network (LAN) card and a modem. The communication part 1809 performs communication through a network such as the Internet. A drive 1810 is also connected to the input/output interface 1805 as required. A removable medium 1811 such as a magnetic disk, an optical disk, a magneto-optical disk, or a semiconductor memory is installed on the drive 1810 as required, so that a computer program read from the removable medium is installed into the storage part 1808 as required.

Particularly, according to the embodiments of this disclosure, the process described in each method flowchart may be implemented as a computer software program. For example, an embodiment of this disclosure includes a computer program product. The computer program product includes a computer program carried on a computer-readable storage medium, the computer program includes program code for performing the methods shown in the flowcharts. In such embodiments, the computer program may be downloaded and installed from a network through the communication part 1809, and/or installed from the removable medium 1811. When the computer program is executed by the central processing unit 1801, various functions defined in a system of this disclosure are executed.

The computer-readable medium according to the embodiments of this disclosure may include a computer-readable signal medium, a computer-readable storage medium, or any combination of the two. The computer-readable storage medium may be, for example, but is not limited to, an electric, magnetic, optical, electromagnetic, infrared, or semi-conductive system, apparatus, or device, or any combination thereof. An example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any suitable combination thereof. In this disclosure, the computer-readable storage medium may be any tangible medium that includes or stores a program. The program may be used by an instruction execution system, apparatus, or device, or may be used in combination with the instruction execution system, apparatus, or device. In this disclosure, the computer-readable signal medium may include a data signal being in a baseband or propagated as a part of a carrier, the data signal carrying computer-readable program code. A data signal propagated in such a way may be in a plurality of forms, including, but not limited to: an electromagnetic signal, an optical signal, or any suitable combination thereof. The computer-readable signal medium may alternatively be any computer-readable medium other than the computer-readable storage medium. The computer-readable medium may transmit, propagate, or transfer a program that is used by or used in combination with an instruction execution system, apparatus, or device. The computer program included in the computer-readable storage medium may be transmitted through any suitable medium, which includes, but is not limited to, a wireless medium, a wired medium, or the like, or any suitable combination thereof.

The flowcharts and block diagrams in the accompanying drawings illustrate system architectures, functions, and operations that may be implemented by the system, the method, and the computer program product according to the embodiments of this disclosure. In this regard, each box in the flowcharts or the block diagrams may represent a module, a program segment, or part of code. The module, the program segment, or the part of the code includes at least one executable instruction for implementing specified logical functions. In some alternative implementations, the functions annotated in the boxes may occur in a sequence different from that annotated in the accompanying drawing. For example, two boxes shown in succession are executed substantially in parallel, or may sometimes be executed in a reverse order, depending on the functions involved. Each box in the block diagram or the flowchart and a combination of boxes in the block diagram or the flowchart may be implemented by using a dedicated hardware-based system configured for performing a specified function or operation, or may be implemented by using a combination of dedicated hardware and computer instructions.

Although several modules or units of a device configured to perform actions are mentioned in the foregoing detailed descriptions, such division is not mandatory. In practice, according to the implementations of this disclosure, the features and functions of two or more modules or units described above may be embodied by one module or unit. Conversely, the feature and function of one module or unit described above may be further divided to be embodied in a plurality of modules or units.

According to the foregoing descriptions of the implementations, a person skilled in the art may readily understand that the implementations described herein may be implemented by using software, or may be implemented by software in combination with necessary hardware. Therefore, the technical solutions in the embodiments of this disclosure may be embodied in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to the implementations of this disclosure.

After considering the specification and practicing the disclosure disclosed herein, a person skilled in the art may easily conceive of other implementations of this disclosure. This disclosure is intended to cover any variations, uses, or adaptive changes of this disclosure. These variations, uses, or adaptive changes follow the general principles of this disclosure and include common general knowledge or common technical means in the art which are not disclosed in this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

This disclosure is not limited to the precise structures described above and shown in the accompanying drawings, and various modifications and changes may be made without departing from the scope of this disclosure.

What is claimed is:

1. An image processing method, the method comprising:
determining, based on a position of a second coding block in a coding unit in a current picture, a target region of the second coding block, the target region being associated with at least one first coding block, the coding unit including the at least one first coding block in a first color component and the second coding block in a second color component;
determining reconstructed samples in the target region according to a prediction mode; and
predicting a value of a sample in the second coding block based on at least one of the reconstructed samples in the target region and a mapping relationship between the at least one of the reconstructed samples in the target region of the first color component and the value of the sample in the second coding block of the second color component when one of (i) a number of non-zero coefficients in the target region of the first color component or (ii) a number of non-zero coefficients in the at least one first coding block of the first color component is greater than a threshold.

2. The method according to claim 1, wherein
the current picture is partitioned based on a single partitioning tree structure to obtain the at least one first coding block and the second coding block;
a coding block in the at least one first coding block corresponding to the second coding block is the target region, and the target region is collocated with the second coding block; and
the number of non-zero coefficients of the entire coding block in the at least one first coding block is greater than the threshold.

3. The method according to claim 1, wherein
a first color component of the current picture is partitioned based on a first partitioning tree structure to obtain the at least one first coding block;
a second color component of the current picture is partitioned based on a second partitioning tree structure to obtain the second coding block;
a partial region or an entire region in the at least one first coding block is the target region, the target region being collocated with the second coding block; and
the first partitioning tree structure is different from the second partitioning tree structure.

4. The method according to claim 3, wherein
the number of non-zero coefficients of the target region of the first color component is greater than the threshold.

5. The method according to claim 3, wherein the at least one first coding block is a first coding block, and the target region of the first color component is one of: (i) a partial region of the first coding block and (ii) an entire region of the first coding block.

6. The method according to claim 3, wherein the at least one first coding block includes a plurality of first coding blocks, and the target region of the first color component is one of: (i) a partial region of the plurality of first coding blocks and (ii) an entire region of the plurality of first coding blocks.

7. The method according to claim 3, wherein the number of non-zero coefficients in the at least one first coding block that corresponds to the target region is greater than the threshold.

8. The method according to claim 7, wherein
when the at least one first coding block includes a plurality of first coding blocks, the partial region in the plurality of first coding blocks is the target region, the number of non-zero coefficients in the entire region of the plurality of first coding blocks is greater than the threshold; and
when the at least one first coding block is a first coding block, the partial region in the first coding block is the target region, the number of non-zero coefficients in the entire region of the first coding block is greater than the threshold.

9. The method according to claim 1, further comprising:
predicting a second value of the sample in the second coding block according to a second prediction mode, the second prediction mode including one of: an intra prediction mode, an inter prediction mode, or an intra block copy prediction mode; and
determining a weighted average of the second predicted value and the predicted value of the second coding block based on a weight coefficient to obtain an updated value of the sample in the second coding block.

10. The method according to claim 1, further comprising:
obtaining a prediction model that indicates the mapping relationship, the obtaining including:
obtaining an initial prediction model, an input to the initial prediction model comprising a first color component of a pixel, an output of the initial prediction model being a second color component of the pixel, and the initial prediction model comprising at least one of a plurality of candidate models;
obtaining a training sample pair, the training sample pair comprising one or more of following sample pairs:
a predicted value of a first color component of a pixel located in the target region and a predicted value of a second color component of a corresponding pixel located in the second coding block; and
a reconstructed value of a first color component and a reconstructed value of a second color component of a pixel located in a reference region, the reference region comprising at least one region neighboring the second coding block; and
performing parameter fitting on the initial prediction model based on the training sample pair to obtain the prediction model.

11. The method according to claim 10, wherein the reference region is formed by combining at least one of (i) a nearest neighboring region or (ii) a second nearest neighboring region, the nearest neighboring region includes a region that is located above or to the left of the second coding block and that has a specified size, and the second nearest neighboring region includes a region that is located to the upper left, lower left, or upper right of the second coding block and that has a specified size.

12. The method according to claim 1, wherein the predicting comprises:
downsampling the reconstructed samples that are within a sampling window of the target region to obtain downsampled samples in the target region, the reconstructed samples that are within the sampling window including the at least one of the reconstructed samples in the target region, one of the downsampled samples in the target region corresponding to the sample in the second coding block; and
obtaining the predicted value of the sample in the second coding block based on the downsampled samples in the target region.

13. The method according to claim 12, wherein
the mapping relationship indicates a relationship between one or more of the downsampled samples in the target region and the value of the sample in the second coding block; and
the obtaining the predicted value of the sample in the second coding block includes obtaining the predicted value of the sample in the second coding block based on the one or more of the downsampled samples in the target region.

14. The method according to claim 12, wherein the downsampling comprises:
determining the one of the downsampled samples in the target region based on a weighted summation of a plurality of the reconstructed samples that are within the sampling window.

15. An image processing apparatus, comprising:
processing circuitry configured to:
determine, based on a position of a second coding block in a coding unit in a current picture, a target region of the second coding block, the target region being associated with at least one first coding block, the coding unit including the at least one first coding block in a first color component and the second coding block in a second color component;
determine reconstructed samples in the target region according to a prediction mode; and
predict a value of a sample in the second coding block based on at least one of the reconstructed samples in the target region and a mapping relationship between the at least one of the reconstructed samples in the target region of the first color component and the value of the sample in the second coding block of the second color component when one of (i) a number of non-zero coefficients in the target region of the first color component or (ii) a number of non-zero coefficients in the at least one first coding block of the first color component is greater than a threshold.

16. The image processing apparatus according to claim 15, wherein
the current picture is partitioned based on a single partitioning tree structure to obtain the at least one first coding block and the second coding block;
a coding block in the at least one first coding block corresponding to the second coding block is the target region, and the target region is collocated with the second coding block; and
the number of non-zero coefficients of the entire coding block in the at least one first coding block is greater than the threshold.

17. The image processing apparatus according to claim 15, wherein
a first color component of the current picture is partitioned based on a first partitioning tree structure to obtain the at least one first coding block;
a second color component of the current picture is partitioned based on a second partitioning tree structure to obtain the second coding block;
a partial region or an entire region in the at least one first coding block is the target region, the target region being collocated with the second coding block; and
the first partitioning tree structure is different from the second partitioning tree structure.

18. The image processing apparatus according to claim 17, wherein
the number of non-zero coefficients of the target region of the first color component is greater than the threshold.

19. The image processing apparatus according to claim 17, wherein the at least one first coding block is a first coding block, and the target region of the first color component is one of: (i) a partial region of the first coding block and (ii) an entire region of the first coding block.

20. A non-transitory computer-readable storage medium storing instructions which when executed by a processor cause the processor to perform a method of encoding a bitstream, the method comprising:
determining, based on a position of a second coding block in a coding unit in a current picture, a target region of the second coding block, the target region being associated with at least one first coding block, the coding unit including the at least one first coding block in a first color component and the second coding block in a second color component;
determining reconstructed samples in the target region according to a prediction mode; and
predicting a value of a sample in the second coding block based on at least one of the reconstructed samples in the target region and a mapping relationship between the at least one of the reconstructed samples in the target region of the first color component and the value of the sample in the second coding block of the second color component when one of (i) a number of non-zero coefficients in the target region of the first color component or (ii) a number of non-zero coefficients in the at least one first coding block of the first color component is greater than a threshold.
